(19) United States
(12) Patent Application Publication
(10) Pub. No.: US 2009/0150483 A1
(43) Pub. Date: Jun. 11, 2009

(54) COMMUNICATION APPARATUS

(75) Inventor: Hiroshi YOKOTA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/164,346

(22) Filed: Jun. 30, 2008

(30) Foreign Application Priority Data
Dec. 10, 2007 (JP) P2007-318633

(51) Int. Cl. G06F 15/16

(52) U.S. Cl. 709/203; 709/206

(57) ABSTRACT

A communication apparatus includes: an input unit; a storage unit; an edit unit that controls the storage unit to store an email address input according to a given operation at the input unit; an email send unit that controls the storage unit to store a destination address of an outgoing email; and an email receive unit that receives a body of an incoming email when a sender's address of the incoming email is stored in the storage unit.

The entire disclosure of Japanese Patent Application No. 2007-318633 filed on Dec. 10, 2007 including specification, claims, drawings and abstract is incorporated herein by reference in its entirety.

### BACKGROUND OF THE INVENTION

1. Field of the Invention

The invention relates to a communication apparatus and, specifically, the invention relates to a processing for receiving an email.

2. Description of the Related Art

Emails, which are transmitted to a communication apparatus such as a mobile communication terminal unit, sometimes, include emails which the user of the communication apparatus does not want to receive. For example, emails for advertising merchandise in which the user is not interested at all. These emails are called nuisance mails or they are also referred to as spam mails.

Thus, in a communication apparatus for transmitting and receiving emails, it is known that emails to be received are filtered. Specifically, such communication apparatus includes a receive permission list for storing email addresses and thus receives only the emails that are transmitted from the email addresses stored in the receiving permission list. Also, a communication apparatus includes a receive reject list for storing emails and thus does not receive the emails that are transmitted from email addresses stored in the receive reject list.

Also, emails transmitted from email addresses which are the destinations of emails once transmitted from a communication apparatus are believed not to be spam mails. Therefore, there is a known processing in which the communication apparatus receives emails also transmitted from email addresses included in a send and receive history stored in the communication apparatus (see JP-A-2003-150512 (Pages 2 to 3, FIG. 1), for instance).

### SUMMARY OF THE INVENTION

However, in the method disclosed in the above-cited JP-A-2003-150512, when determining whether the communication apparatus is allowed to receive an email or not, it is necessary to refer to a large number of email address lists, for example, the receive permission list and send history. This provides a problem that it takes long time to carry out such determining processing. Especially, in the send history, there are sometimes stored the email addresses of the destinations of the emails transmitted in time series order and some of the email addresses can be stored duplicately. In this case, the determining processing takes longer time.

The invention aims at solving the above-mentioned problems and thus it is an object of the invention to provide a communication apparatus which not only can easily store email addresses stored in a send history into a receive permission list but also can easily delete these addresses from a receive reject list.

According to one aspect of the invention, a communication apparatus includes: an input unit; a storage unit; an edit unit that controls the storage unit to store an email address input according to a given operation at the input unit; an email send unit that controls the storage unit to store a destination address of an outgoing email; and an email receive unit that receives a body of an incoming email when a sender's address of the incoming email is stored in the storage unit.

According to another aspect of the invention, a communication apparatus includes: an input unit; a storage unit; an edit unit that controls the storage unit to store an email address input according to a given operation at the input unit; an email send unit that controls the storage unit to delete a destination address of an outgoing email when the destination address is stored in the storage unit; and an email receive unit that does not receive a body of an incoming email when a sender's address of email address of the email is stored in the storage unit.

### BRIEF DESCRIPTION OF THE DRAWINGS

Embodiment may be described in detail with reference to the accompanying drawings, in which:

FIG. 1 is a block diagram of the structure of a mobile communication terminal unit according to a first embodiment of the invention;

FIG. 2 is a table of an example of the structure of an email entity according to a first embodiment of the invention;

FIG. 3 is a table of an example of the structure of an email send history according to a first embodiment of the invention;

FIG. 4 is a table of an example of the structure of a receive permission list according to a first embodiment of the invention;

FIG. 5 is a table of an example of the structure of a receive reject list according to a first embodiment of the invention;

FIG. 6 is a flow chart of an operation to be carried out by an email send and receive portion according to a first embodiment of the invention when transmitting an email;

FIG. 7 is a flow chart of an operation to set an email send and receive portion according to the first embodiment of the invention in such a manner that it will receive an email having a destination email address as the sender thereof;

FIG. 8 is a flow chart of an operation to be carried out by the email send and receive portion according to the first embodiment of the invention when it checks whether it should receive an email or not and then it receives the email or it does not receive the same;

FIG. 9 is a flow chart of an operation to set an email send and receive portion according to a first embodiment of the invention in such a manner that it will not receive an email transmitted from the sender of an email received;

FIG. 10 is a flow chart of an operation to set an email send and receive portion according to a first embodiment of the invention in such a manner that it will not receive an email having an email address stored in an email send history as the sender thereof;

FIG. 11 is a flow chart of an operation to be carried out by a permission and reject list edit portion when it edits a receive permission list according to a first embodiment of the invention;

FIG. 12 is a flow chart of an operation to be carried out by the permission and reject list edit portion according to a first embodiment of the invention when it edits a receive reject list;

FIG. 13 is a view of an example (a first example) of receive permission email addresses displayed on a display portion by the permission and reject list edit portion according to the first embodiment of the invention;

FIG. 14 is a view of an example (a first example) of receive reject email addresses displayed on the display portion by the permission and reject list edit portion according to the first embodiment of the invention;

FIG. 15 is a view of an example in which an email being created by the email send and receive portion according to the first embodiment of the invention is displayed on the display portion;

FIG. 16 is a view of an example in which a message, telling to the effect that an email is being transmitted by the email send and receive portion according to the first embodiment of the invention, is displayed on the display portion;

FIG. 17 is a view of an example (a second example) of the receive permission email addresses displayed on the display portion by the permission and reject list edit portion according to the first embodiment of the invention;

FIG. 18 is a view of an example (a second example) of receive reject email addresses displayed on the display portion by the permission and reject list edit portion according to the first embodiment of the invention;

FIG. 19 is a block diagram of the structure of a mobile communication terminal unit according to a second embodiment of the invention;

FIG. 20 is a flow chart of an operation to set an email send and receive portion according to the second embodiment of the invention in such a manner that it will receive an email having a destination email address as the sender thereof;

FIG. 21 is a flow chart of an operation to be carried out by the email send and receive portion according to the second embodiment of the invention when it checks whether it should receive an email or not and then it receives the email or it does not receive the same;

FIG. 22 is a flow chart of an operation to set an email send and receive portion according to a second embodiment of the invention in such a manner that it will not receive an email transmitted from the sender of an email received;

FIG. 23 is a flow chart of an operation to set an email send and receive portion according to a second embodiment of the invention in such a manner that it will not receive an email having an email address stored in an email send history as the sender thereof.

FIG. 24 is a block diagram of the structure of a mobile communication terminal unit according to a third embodiment of the invention;

FIG. 25 is a flow chart of an operation to set an email send and receive portion according to the third embodiment of the invention in such a manner that it will receive an email having a destination email address as the sender thereof;

FIG. 26 is a flow chart of an operation to be carried out by the email send and receive portion according to the third embodiment of the invention when it checks whether it should receive an email or not and then it receives the email or it does not receive the same;

FIG. 27 is a flow chart of an operation to set an email send and receive portion according to a third embodiment of the invention in such a manner that it will not receive an email transmitted from the sender of an email received; and

FIG. 28 is a flow chart of an operation to set the email send and receive portion according to the third embodiment of the invention in such a manner that it will not receive an email having an email address stored in an email send history as the sender thereof.

### DETAILED DESCRIPTION OF THE INVENTION

Now, description will be given below of embodiments of a communication unit according to the invention.

### First Embodiment

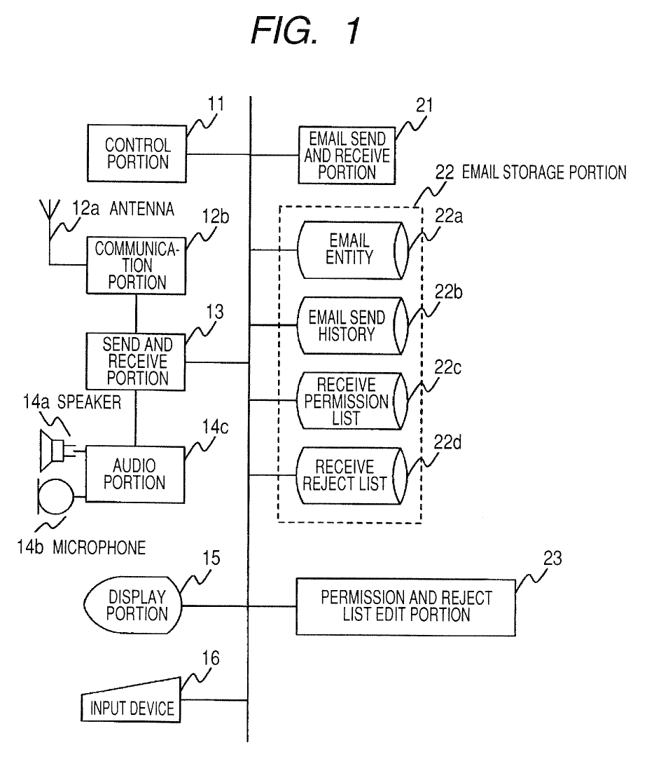

FIG. 1 is a block diagram of the structure of a mobile communication terminal unit to which a communication apparatus according to a first embodiment of the invention is applied.

This mobile communication terminal unit is a unit which carries out communication through a mobile communication network (not shown). Specifically, this terminal unit includes a control portion 11 for controlling the whole of the unit, an antenna 12a for transmitting and receiving radio waves to and from a base station, a communication portion 12b, a send and receive portion 13, a speaker 14a for generating receive sounds, a microphone 14b for inputting send sounds, an audio portion 14c, a display portion 15, and an input device 16.

This mobile communication terminal unit further includes an email send and receive portion 21, an email storage portion 22, and a permission and reject list edit portion 23. In the email storage portion 22, there are stored an email entity 22a containing a received email, a send history 22b containing the email addresses of the destinations of emails transmitted, a receive permission list 22c containing the email addresses that are permitted to receive, and a receiving reject list 22d containing the email addresses that are rejected to receive.

Now, description will be given here of the operations of the respective composing portions of the mobile communication terminal unit according to the first embodiment with reference to FIG. 1. The communication portion 12b outputs a high frequency signal, which has been received by the antenna 12, to the send and receive portion 13; and also, the communication portion 12b transmits the high frequency signal, which has been output from the send and receive portion 13, from the antenna 12a.

The send and receive portion 13 amplifies, frequency converts and demodulates the high frequency signal transmitted from the communication portion 12b to thereby obtain a digital signal; and, the send and receive portion 13 transmits the thus obtained talk sound signal to the audio portion 14c, a control signal containing an incoming signal to the control portion 11, and an email to the email send and receive portion 21, respectively.

Further, the send and receive portion 13 modulates, frequency converts and amplifies a digital signal, that is, a talk sound signal output from the audio portion 14c, a control signal output from the control portion 11, and an email output from the email send and receive portion 21 to thereby obtain a high frequency signal; and then, the send and receive portion 13 transmits the high frequency signal to the communication portion 12b, thereby allowing the communication portion 12b to transmit the high frequency signal.

The audio portion 14c converts a digital sound signal output from the send and receive portion 13 to an analog sound signal, amplifies the analog signal, and transmits the amplified analog signal to the send and receive portion 13.

The display portion 15 is made of, for example, an LCD and, when it is controlled by the control portion 11, it carries out an operation to display characters and numerals or video data; and, the data being displayed can be switched when the display portion 15 receives an instruction from the control portion 11 in response to an input operation or a receiving signal from the input device 16.

The input device 16 has keys including numeral keys and a plurality of function keys which are used to specify the telephone number of a communication person and also to create an email by inputting characters of a toggle system. And, when any key of the input device 16 is operated, the identifier of the key is notified and is displayed as characters on the display portion 15 or is controlled by the control portion 11.

The email send and receive portion 21 is a processing portion which transmits and receives an email. According to an instruction from the control portion 11 based on the operation of a given key of the input device 16, the email send and receive portion 21 initiates its operation, that is, transmits an email. In other words, according to the given key operation at the input device 16, the email send and receive portion 21 inputs the email address of the destination of the email, the subject thereof and the body thereof. And, the email send and receive portion 21 instructs the transmitting and receiving portion 13 such that a mail server device is allowed to transmit the thus-input subject of the email and the body thereof to the thus input destination email address. Also, the destination email address of the email may also be selected in a different manner. That is, the email send history 22b may be displayed in a sight list manner on the display portion 15 and the target mail address maybe selected from the addresses of the displayed list according to a given key operation at the input device 16.

This email is transmitted through the communication portion 12b, antenna 12a and base station and further through a mobile communication network to a mail server device (not shown). Also, the email send and receive portion 21 allows the email storage portion 22 to store therein the destination email address of the thus transmitted email as the email send history 22b. And, in some cases, in order that the email transmitted from the destination email address can be received, the receive permission list 22c and/or receive reject list 22d are updated and stored.

The email send and receive portion 21 starts its operation according to an instruction given from the control portion 11 when the control portion 11 receives an email receiving signal, and receives the header of the email including the email address of the sender of the email sent from the mail server device. And, based on the sender's email address, the email send and receive portion 21 determines whether it should receive the above email or not. In this determination, the email send and receive portion 21 refers to the receive permission list 22c and receive reject list 22d.

When it is determined that the email send and receive portion 21 should receive the email, it notifies the mail server device of the determination; and, the email send and receive portion 21 receives the body of the email sent from the mail server device according to the notice of the determination as well as an attached file if it is attached to the email. And, the body and attached file, together with the header of the email already received, are stored as the email entity 22a into the email storage portion 22. On the other hand, when it is determined that the email should not be received, the email send and receive portion 21 notifies the mail server device of this determination and cancels the header of the email already received.

And, the email send and receive portion 21 initiates its operation according to an instruction from the control portion 11 based on a given key operation at the input device 16, and allows the display portion 15 to display thereon the email contained in the email entity 22a. Also, the email send and receive portion 21 deletes the above-identified electronic entity 22a according to a given key operation at the input device 16. Further, in some cases, in order that an email sent from the email address of the sender of the email entity 22a should not be received, the receive permission list 22c and/or receive reject list 22d are updated and stored.

Further, according to an instruction from the control portion 11 based on a given key operation at the input device 16, the email send and receive portion 21 starts its operation and allows the display portion 15 to display thereon the email address that is the email send history 22b. And, according to a given key operation at the input device 16, the email send and receive portion 21 deletes the email address specified. In some cases, together with this mail address deletion, in order that an email having the thus deleted email address as the sender's email address can be prevented from being received, the receive permission list 22c and/or receive reject list 22d are updated and stored.

Further, the permission and reject list edit portion 23 edits email addresses contained in the receive permission list 22c and email addresses contained in the receive reject list 22d. That is, according to an instruction from the control portion 11 based on a given key operation at the input device 11, the permission and reject list edit portion 23 starts its operation and, according to a given key operation at the input device 11, the permission and reject list edit portion 23 carries out the addition, deletion and updating of the email addresses contained in the receive permission list 22c and receive reject list 22d, and allows the email storage portion 22 to store therein the thus updated email addresses.

Now, description will be given below of the operations of the respective portions of the mobile communication terminal unit according to the present embodiment that are involved with a processing to be executed by the email send and receive portion 21 for determining whether an email should be received or not depending on the email address of the sender of the email.

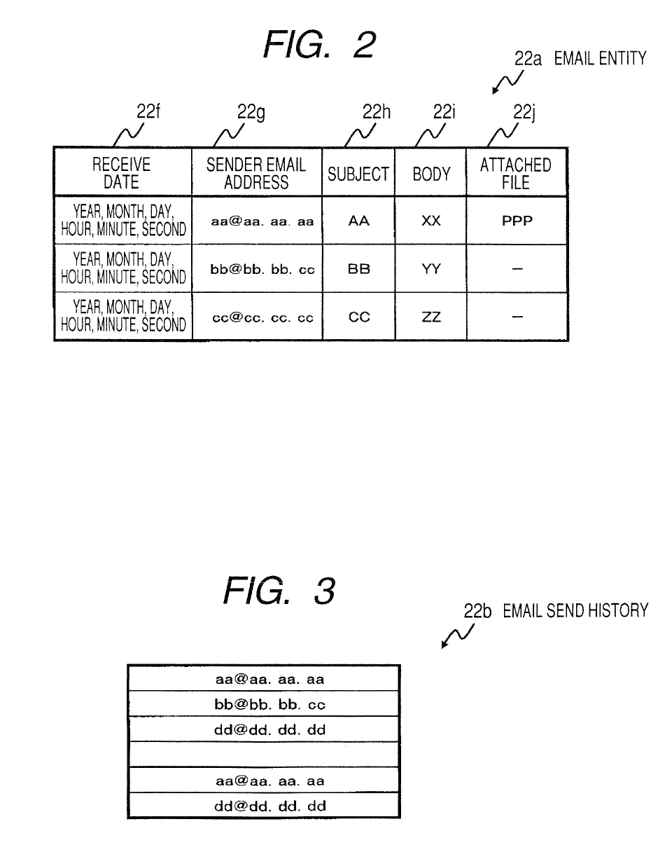

FIG. 2 shows an example of the structure of the email entity 22a to be stored in the email storage portion 22. This email entity 22a is information in which a receive date 22f, a sender's email address 22g, a subject name 22h, a body 22i and an attached file 22j are related to each other; and, a set of related information provides an email received.

The receive data 22f is a date that is contained in the header of an email. The sender's email address 22g is the email address of the sender of the email. The subject 22h is the subject that is contained in the header of the email. The body 22i is the body of the email. The attached file 22j is the file that is attached to the email.

According to the illustration of FIG. 2, the receive date 22f, sender's email address 22g, subject 22h, body 22i and attached file 22j are stored continuously and the related pieces of information are stored continuously. This illustration is employed in order to facilitate the understanding of the structure of the email entity 22a. The invention is not limited to this but, for example, there may also be employed a structure in which the composing elements are stored discretely and the discretely arranged elements are connected to each other by pointers.

Especially, since the attached file can provide a possibility that it requires a large storage capacity, the attached file may also be stored in a storage portion separately formed exclusively for storage of an attached file; and, in the attached file 22j, there may also be stored a pointer which designates the storage portion exclusively formed for storage of an attached file. Alternatively, the attached file may also be stored as a file by the management function of a file system which is a portion of the function of the control portion 11 and, in the attached file 22j, there may also be stored information that identifies the file.

FIG. 3 shows an example of the email send history 22b that is stored into the email storage portion 22. This electronic send history 22b is composed of a given number or a smaller number of email addresses. These email addresses are the email addresses that are the destinations of emails sent by the email send and receive portion 21.

When an email is transmitted to a plurality of destinations, the email addresses of the plurality of destinations are stored. And, the email addresses are stored without duplicating the same email address while keeping a time-series order. For example, the email addresses are stored in such a manner that an email address stored in the nearest past can be accessed first.

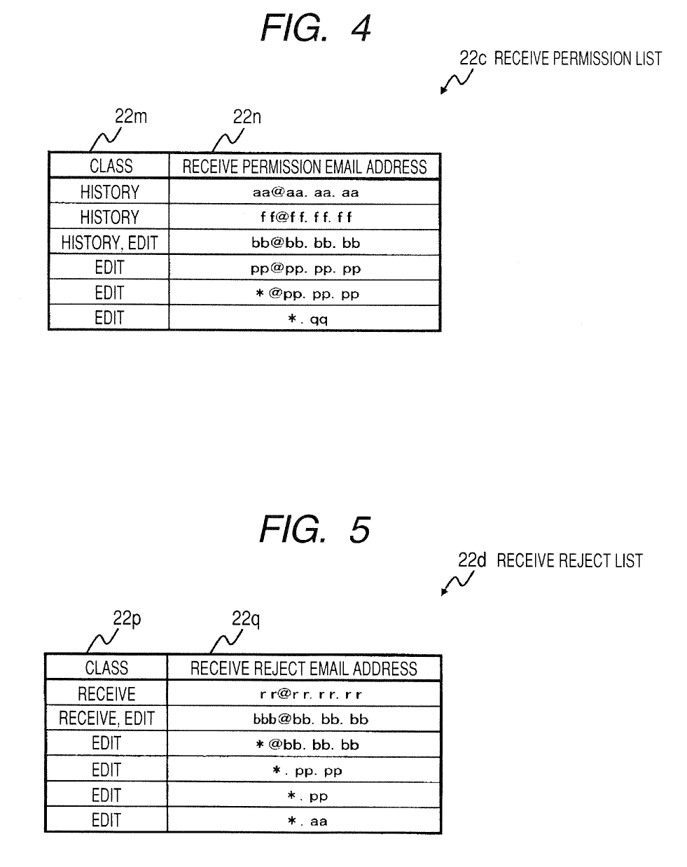

FIG. 4 shows an example of the structure of the receive permission list 22c to be stored in the email storage portion 22. This receive permission list 22c is composed of information in which a class 22m and a receive permission email address 22n are related to each other.

The class 22m is “history”, or, “edit”, or both of them. The history expresses that the related receive permission email address 22n has been stored based on the email send history 22b. Also, the edit expresses that the related receive permission email address 22n has been stored according to the operation of the permission and reject list edit portion 23.

When the class 22m is “history and edit” (in FIG. 4, it is expressed as “history, edit”), the class 22m shows that the related receive permission email address 22n has been stored based on the email send history 22b and according to the operation of the permission and reject list edit portion 23.

The receive permission email address 22n is an email address which shows that an email having the receive permission email address 22n as its sender's email address is to be received. Alternatively, the receive permission email address 22n may also be composed of a domain name which is a portion of an email address, or, a portion of the domain name. In this case, the receive permission email address 22n shows that an email having the receive permission email address 22n as the domain name of the sender's email address, or, an email having the receive permission email address 22n as the portion of the domain name of the sender's email address is to be received.

For example, in FIG. 4, a receive permission email address 22n expressed as [*@pp.pp.pp] shows that an email with the domain of the sender's email address thereof expressed as [pp.pp.pp] is to be received. Also, a receive permission email expressed as [.qq] shows that an email with its top level domain, namely, a portion of the domain name of its sender's email address (the domain name is divided by, [.] and the top level domain is the most rightward item after divided) expressed as [qq] is to be received.

According to the illustration of FIG. 4, the class 22m and receive permission email address 22n are stored continuously and the related pieces of information are stored continuously. However, this illustration is employed to facilitate the understanding of the structures of the class 22m and receive permission email address 22n. This is not limitative but, for example, there may also be employed a structure in which the composing elements are stored discretely and the discretely arranged elements are connected to each other by pointers.

Also, the receive permission list 22c may be preferably stored in such a manner that it is sorted by the receive permission email address 22n. Also, an index may also be added to the receive permission list 22c; and, the receive permission list 22c may also be stored after it is hashed. The sorting order may be decided according to the email addresses, or according to the domain names or portions of the domain names.

FIG. 5 shows an example of the receive reject list 22d to be stored in the email storage portion 22. This receive reject list 22d is a piece of information in which the class 22p and receive reject email address 22q are related to each other.

The class 22m means “receive” or “edit”, or both of them. The “receive” expresses that the related receive reject email address 22q has been stored according to the sender's email address of an email received by the email send and receive portion 21. Also, the “edit” expresses that the related receive reject email address 22q has been stored by the operation of the permission and reject list edit portion 23.

When the class 22m means “receive” and “edit” (in FIG. 5, this case is expressed as “receive, edit”), the class 22m shows that the related receive reject email address 22q has been stored not only has been stored according to the sender's email address of the email received by the email send and receive portion 21 but also has been stored by the operation of the permission and reject list edit portion 23.

The receive reject email address 22q is an email address which shows that an email having the receive reject email address 22q as the sender's email address thereof should be rejected. Alternatively, the receive reject email address 22q may also be a domain name which is a portion of an email address, or, a portion of the domain name. This means that an email having the receive reject email address 22q composed of the domain name of the sender's email address, or an email having the receive reject email address 22q composed of a portion of the domain name of the sender's email address should be rejected.

For example, in FIG. 5, a receive reject email address 22q expressed as [*@bb.bb.bb] means that an email having the domain name of the sender's email address expressed as [bb.bb.bb] should be not received. Also, a receive reject email address 22q expressed as [*.pp.pp] means that an email having the two right items of the email address thereof, that is, a portion of the domain name of the sender's email address expressed as [pp.pp] should be not be received. Further, a receive reject email address 22q expressed as [pp] means that an email having a top level domain, that is, a portion of the domain name of the sender's email address expressed as [pp] should be rejected.

When an email having a top level domain, that is, a portion of the domain name of the sender's email address expressed as [pp] should be rejected, of course, an email having the two right items of the mail address thereof, that is, a portion of the domain name of the sender's email address expressed as [pp.pp] should not be received. However, as shown in FIG. 5, it does not raise any problem at all that one domain name or a portion thereof contains a portion of the other domain name.

According to the illustration of FIG. 5, the class 22p and receive reject email address 22q are continuously stored as well as the related pieces of information are continuously stored. This illustration is employed in order to facilitate the understanding of the structure of the receive reject list 22d. However, this is not limitative but, for example, there may also be employed a structure in which the above elements are stored discretely and the discrete elements are connected together by a pointer.

Also, the receive reject list 22d, preferably, may be sorted by the receive reject email address 22q and may be stored. Alternatively, an index may be added to the receive reject list 22d, or it may be hashed and then stored. The sorting sequence may be decided according to the email addresses, or domain names, or the portions of the domain names.

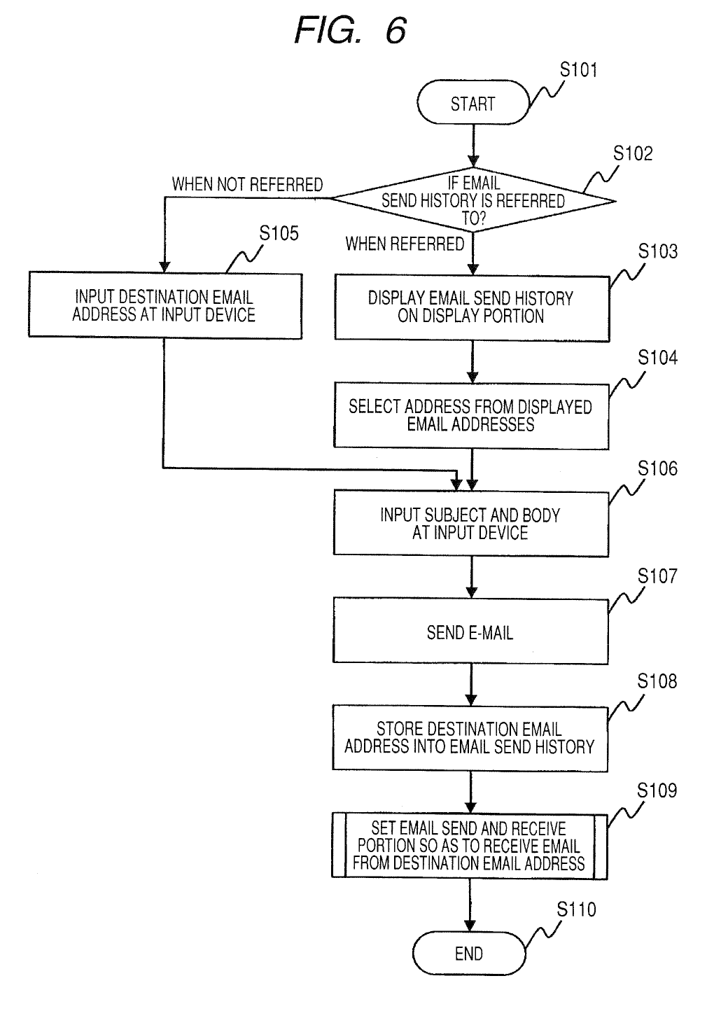

Next, description will be given below of an operation which, when the email send and receive portion 21 transmits an email, updates information stored in the email storage portion 22, that is, an operation to update the information that is so stored in the email storage portion 22 as to receive an email having a destination email address as the sender thereof. FIG. 6 shows a flow chart of the operation of the email send and receive portion 21 when it transmits an email.

The email send and receive portion 21 starts an email send operation according to an instruction given from the control portion 11 based on a given key operation at the input device 16 (Step S101). And, according to a given key operation at the input device 16, the email send and receive portion 21 checks whether the destination email address of an email to be transmitted is selected with reference to the email send history 22b or not (Step S102).

When it is determined that the email address send history 22b should be referred to, the email send and receive portion 21 allows the display portion 15 to display the email send history 22b thereon (Step S103). Here, the email send history 22b stored in the near past is displayed at such a position that can be selected with a reduced number of operations. In order to select the email send history 22b that was stored in the far past, the number of necessary operations may also be large. The reason for this is as follows: That is, since an email is often sent again to the email address to which an email has been recently sent, it is desirable to select the recently stored email address easily.

Next, the email send and receive portion 21 selects one or more of the email send history 22b displayed on the display portion 15 according to a given key operation at the input device 16, and specifies it or them as a destination email address or destination email addresses (Step S104).

On the other hand, in Step S102, when it is determined that the email send history 22b should not be referred to, the email send and receive portion 21, according to a given key operation at the input device 16, inputs one or more destination email addresses (Step S105). Here, the selection of the destination email address in Step S104 and the input of the destination email address in Step S105 are not exclusive to each other, but both of them may also be carried out.

After the selection of the destination email address in Step S104, or after the input of the destination email address in Step S105, the email send and receive portion 21, according to a given key operation at the input device 16, inputs the subject and body of the email (Step S106) and allows the send and receive portion 13 to transmit the thus input subject and body to the above-mentioned destination email address (Step S107).

Next, the email send and receive portion 21 allows the email storage portion 22 to store the above destination email address as the email send history 22b (Step S108). In this storage operation, the destination email addresses are stored while keeping the sequence of time when they are stored. Also, since the number of the email addresses to be stored in the email send history 22b is limited to a given number or less, when the number of the email addresses to be stored in Step S108 exceeds the given number, the email send and receive portion 21 deletes the email address that was stored in the farthest past.

Here, in conjunction with this delete processing, there a rises no possibility that the receive permission list 22c and/or receive reject list 22d can be updated and stored. The reason for this is that this delete operation relates to a storage capacity and thus has no connection with an email which the user does not want to receive. By the way, description will be given later of an operation which updates and stores the receive permission list 22c and/or receive reject list 22d in conjunction with the deletion of the email address stored in the electronic send history 22b.

Next, in order that an email transmitted from the above destination email address can be received, the receive permission list 22c and/or receive reject list 22d are updated and stored according to the stored receive permission list 22c and receive reject list 22d (Step S109), and then the email send operation is ended (Step S110).

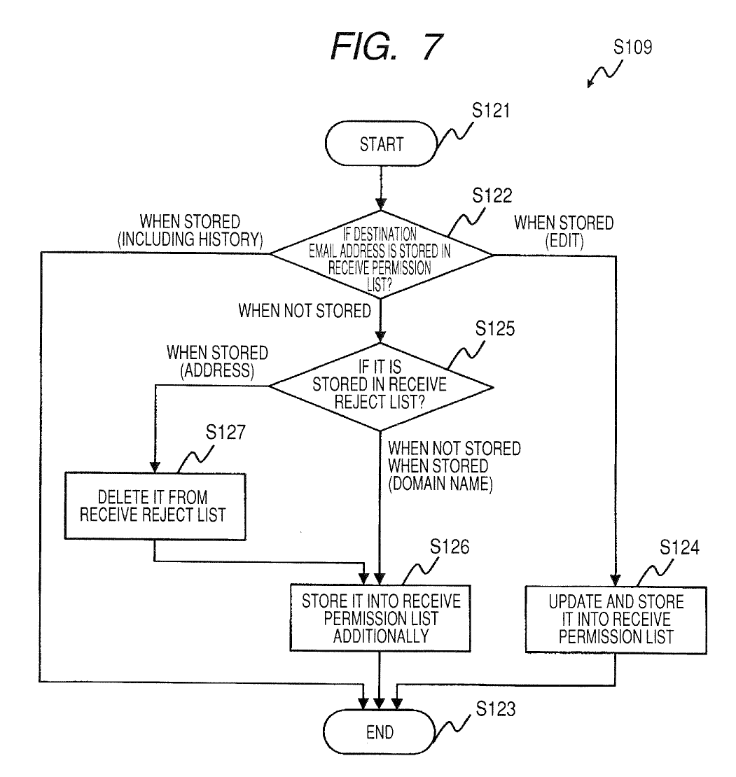

Now, description will be given of the operation to be executed in Step S109 by the email send and receive portion 21. FIG. 7 shows a flow chart of the operation of the email send and receive portion 21 to update and store the receive permission list 22c and/or receive reject list 22d in Step S109. Specifically, the email send and receive portion 21 starts this update and storage operation (Step S121), and checks whether the destination email address is stored as the receive permission email address 22n of the receive permission list 22c or not. When it is found that the destination email address is stored as the receive permission email address 22n, the email send and receive portion 21 obtains the class 22m stored while it is related to the receive permission email address 22n, and determines whether it is necessary to update the above-mentioned lists or not (Step S122).

When the destination email address is stored as the receive permission email address 22n and the obtained class 22m contains “history”, that is, when the class 22m is “history” or [“history” and “edit”], the email send and receive portion 21 ends the updating and storing operation thereof (Step S123). The reason for this is as follows: that is, in this case, since the class 22m shows that the destination email address is already stored in the receive permission list 22c and such storage is made according to the email send history 22b, it is not necessary at all to update the above lists.

When the destination email address is stored as the receive permission email address 22n and the obtained class 22m is “edit”, the email send and receive portion 21 changes the class 22m to [“history” and “edit”] to thereby update and store the same into the receive permission list (Step S124), and then ends the updating and storing operation thereof (Step S123). The reason for this is as follows: that is, although the destination email address is already stored in the receive permission list 22c, it is necessary to update and store that such storage is made according to the email send history 22b as well.

When the destination email address is not stored as the receive permission email address 22n, the email send and receive portion 21 checks whether the destination email address is stored in the receive reject email address 22q of the receive reject list 22d or not. And, when the destination email address is stored as the receive permission email address 22n, the email send and receive portion 21 checks whether the destination email address is stored as the receive reject email address 22q or not, and also whether the domain name of the destination email address or a portion of the domain name of the address is stored or not (Step S125).

When the destination email address is not stored as the receive reject email address 22q, and when the domain name of the destination email address or a portion of the domain name of the destination email address is stored as the receive reject email address 22q, the email send and receive portion 21 adds and stores, as the class 22m, “history” and, as the receive permission email address 22n, the related information serving as the destination email address in the receive permission list 22c (Step S126), and then ends the updating and storing operation thereof (Step S123).

When the destination email address is not stored as the receive reject email address 22q, even without carrying out the addition and storage operation in Step S126, the email send and receive portion 21 receives an email having the destination email address as the sender thereof. However, after this operation, preferably, the above-mentioned addition and storage operation may be carried out in order that, when, for example, the domain name of the destination email address is added and stored to the receive reject email address 22q by the permission and reject list edit portion 23, an email having the destination email address as the sender can be received successively.

When the domain name of the destination email address or a portion of the domain name of the destination email address is stored as the receive reject email address 22q, by carrying out the above-mentioned addition and storage operation, an email having the destination email address as the sender can be received.

When the destination email address is stored as the receive reject email address 22q in Step S125, the email send and receive portion 21 deletes a receive reject list 22d in which the receive reject email address 22q is the destination email address (Step S127). After then, as the class 22m, a piece of related information, in which the receive permission email address 22n is the destination email address, is added to and stored into the receive permission list 22c (Step S126), thereby ending the updating and storing operation (Step S123).

Here, even without executing the receive reject list 22d deleting operation in Step S127, the addition and storage operation of the information to the receive permission list 22c in Step S126 enables the receiving of an email having the destination email address as the sender thereof. Thus, the deleting operation in Step S127 may be omitted. However, according to this deleting operation, even when the receive permission list 22c added and stored by the operation in Step S127 is deleted by the permission and reject list edit portion 23, an email having the destination email address as the sender thereof can be received.

In Step S125, when the destination email address is stored as the receive reject email address 22q and the domain name of the destination email address or a portion of such domain name is stored, the email send and receive portion 21 carries out not only the operation to delete the receive reject list 22d with the receive reject email address 22q stored as the destination email address in Step S127 but also the operation to add and store the receive permission list 22c with the receive permission email address 22n stored as the destination email address in Step S126 (these operations are not shown).

When the destination email address is composed of a plurality of addresses, the email send and receive portion 21 repeats the operations in Steps S121˜S127 respectively described hereinabove with reference to the flow chart shown in FIG. 7, with respect to each of the destination email addresses.

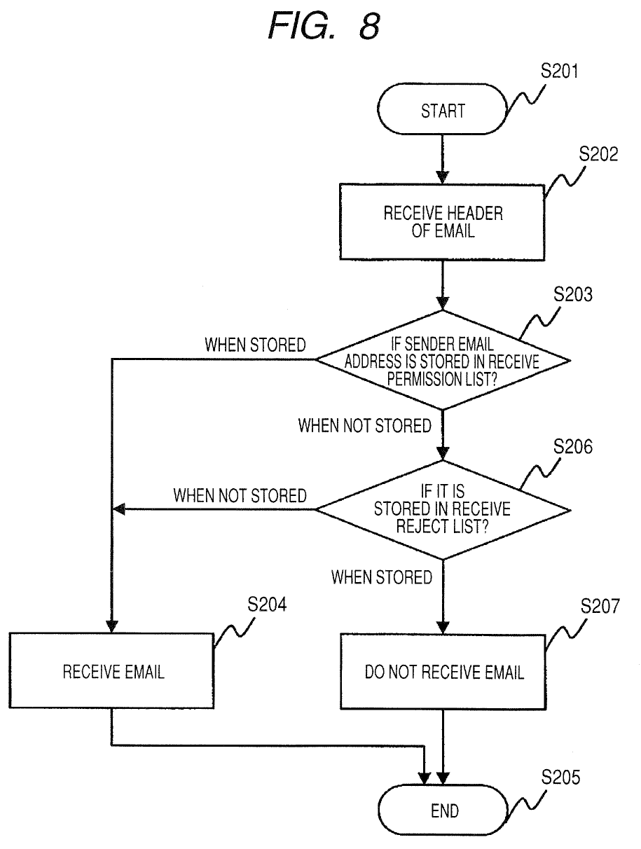

Next, description will be given below of an operation which, when the email send and receive portion 21 receives an email, checks according to the sender's email address of the email whether the email can be received or not. FIG. 8 shows a flow chart of an operation to be executed when the email send and receive portion 21 receives an email. The email send and receive portion 21, according to an instruction from the control portion 11 when an email incoming signal is received, starts an operation to receive an email (Step S201), and receives the header of an email transmitted from a mail server device and received by the send and receive portion 13 (Step S202).

And, the email send and receive portion 21 checks whether the sender's email address contained in the email is stored as the receive permission email address 22n in the receive permission list 22c or not (Step S203). Here, when the domain name of the sender's email address or a portion of such domain name is stored in the receive permission email address 22n, it is determined that the sender's email address is stored in the receive permission list 22c.

When the sender's email address is stored in the receive permission list 22c, the email send and receive portion 21 determines that it receives the email. And, the email send and receive portion 21 instructs the send and receive portion 13 to the effect that it receives the email and notifies the mail server device of that effect. Thus, the email send and receive portion 21 receives the body of the email transmitted from the mail server device in response to such notice and a file attached to the email if the file is attached.

And, into the email storage portion 22, there is stored an email entity 22a in which the time contained in the header received is set in the receive data 22f, the sender's email address contained in the header is set in the sender's email address 22g, the subject contained in the header is set in the subject 22h, the body received is set in the body 22i, and, if an attached file is received, the attached file is set in the attached file 22j (Step S204), thereby ending the operation to receive the email (Step S205).

On the other hand, when the sender's email address is not stored in the receive permission list 22c in Step S203, the email send and receive portion 21 checks whether the sender's email address of the email is stored as the receive reject email address 22q in the receive reject list 22d or not (Step S206). Here, when the domain name of the sender's email address or a portion of such domain name is stored in the receive reject email address 22q, it is determined that the sender's email address is stored in the receive reject list 22d.

When the sender's email address is stored in the receive reject list 22d, the email send and receive portion 21 determines that it should not receive the email. Thus, the email send and receive portion 21 instructs the send and receive portion 13 to transmit to the mail server device a message to the effect that it does not receive the email, and further cancels the header of the email already received (Step S207), thereby ending the operation to receive the email (Step S205).

On the other hand, when the sender's email address is not stored in the receive reject list 22d in Step S206, the email send and receive portion 21 determines that it should receive the email and, as described above, receives the email, and allows the email storage portion 22 to store the received email (Step S204), thereby ending the operation to receive the email (Step S205).

Here, when the sender's email address is not stored in the receive reject list 22d in Step S206, the sender's email address of the email is stored in neither the receive permission list 22c nor the receive reject list 22d. Therefore, the email send and receive portion 21 may not receive the email immediately but may allow the display portion 15 to display the sender's email address and subject of the email and, according to a given key operation at the input device 16, may determine whether it should receive the email or not.

When a plurality of email incoming signals are received, the email send and receive portion 21 carries out the above-mentioned email receiving operation with respect to each of the emails. Here, when checking whether the email should be received or not, the email send and receive portion 21 refers to the receive permission list 22c and receive reject list 22d but does not refer to the email send history 22b, thereby being able to realize a high speed processing. Especially, in some cases, in the email send history 22b, there can be stored the same email address duplicately. In view of this, no reference to the email send history 22b provides a great effect.

Next, description will be given below of an operation in which the email send and receive portion 21 allows the display portion 15 to display the email entity 22a and also, in order that an email transmitted from the email address of the displayed email entity 22a will not be received, updates and stores the receive permission list 22c and/or receive reject list 22d.

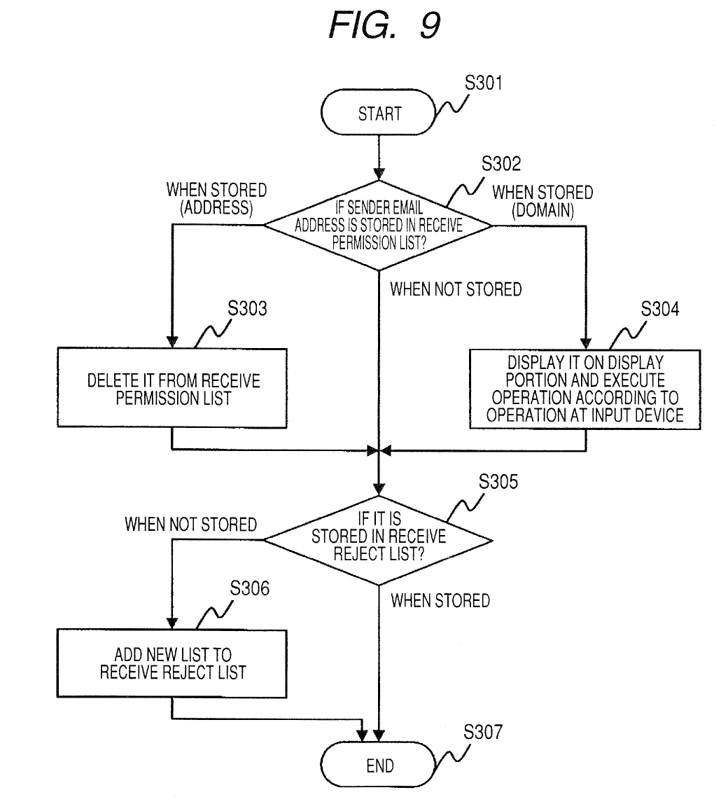

FIG. 9 shows a flow chart of the operation in which, in order that an email transmitted from the email address of the displayed email entity 22a will not be received, the email send and receive portion 21 updates and stores the receive permission list 22c and/or receive reject list 22d.

The email send and receive portion 21, while the email entity 22a is being displayed, according to a given key operation at the input device 16, starts the operation in which an email transmitted from the email address of the displayed email entity 22a will not be received (Step S301). Firstly, the email send and receive portion 21 checks whether the email address of the sender of the mail is stored as the receive permission email address 22n in the receive permission list 22c or not; and, when stored, email send and receive portion 21 checks whether the email address is stored or not, or whether the domain name of the email address or a portion of such domain name is stored or not (Step S302).

When such email address is stored, the email send and receive portion 21 deletes the receive permission list 22c in which the receive permission email address 22n is the email address (Step S303). Also, when the domain name of the email address or a portion of such domain name is stored, the email send and receive portion 21 allows the display portion 15 to display such storage thereon and carries out an operation according to a given key operation at the input device 16 (Step S304).

As the operation to be executed in this step S304, there are at least three available operations to select. The first of them is an operation to delete the receive permission list 22c in which the receive permission email address 22n is the above-mentioned domain name or a portion of such domain name. The second is an operation not to update the receive permission list 22c.

The third is an operation to delete the receive permission list 22c in which the receive permission email address 22n is the above-mentioned domain name or a portion of such domain name, and selects an email address that is the sender's email address of the email entity 22a and is contained in the receive permission list 22c in which the domain name of the present email address or a portion of such domain is deleted. And, the email send and receive portion 21 stores additionally a receive permission list 22c in which the selected email address is regarded as the receive permission email address 22n and “edit” is regarded as the class 22.

When the above email address is stored and the domain name of the email address or a portion of such domain name is stored, the email send and receive portion 21, after execution of the operation in Step S303, carries out the operation in Step S304 (not shown).

When the above email address is not stored in Step S302, when the operation in Step S303 is ended, and when the operation in Step S304 is ended, the email send and receive portion 21 checks whether the email address of the above sender is stored as the receive reject email address 22q in the receive reject list 22d or not. Here, the email send and receive portion 21 does not check whether that email address is stored or not and the domain name of such email address or a portion of such domain portion is stored or not (S305).

When not stored, the email send and receive portion 21 additionally stores a receive reject list 22d in which the present email address is the receive reject email address 22q and “receive” is the class 22p (Step S306), thereby ending the operation in which the email transmitted from the email address of the sender is made not to be received (Step S307). On the other hand, when stored, the email send and receive portion 21 does not update the receive reject list 22d but ends the above operation (Step S307).

Next, description will be given below of an operation in which the email send and receive portion 21 allows the display portion 15 to display thereon email addresses contained in the email send history 22b, deletes a specified email address of the displayed email address from the email send history 22b, and updates and stores the receive permission list 22c and/or receive reject list 22d in such a manner not to receive an email having the deleted email address as the sender's email address.

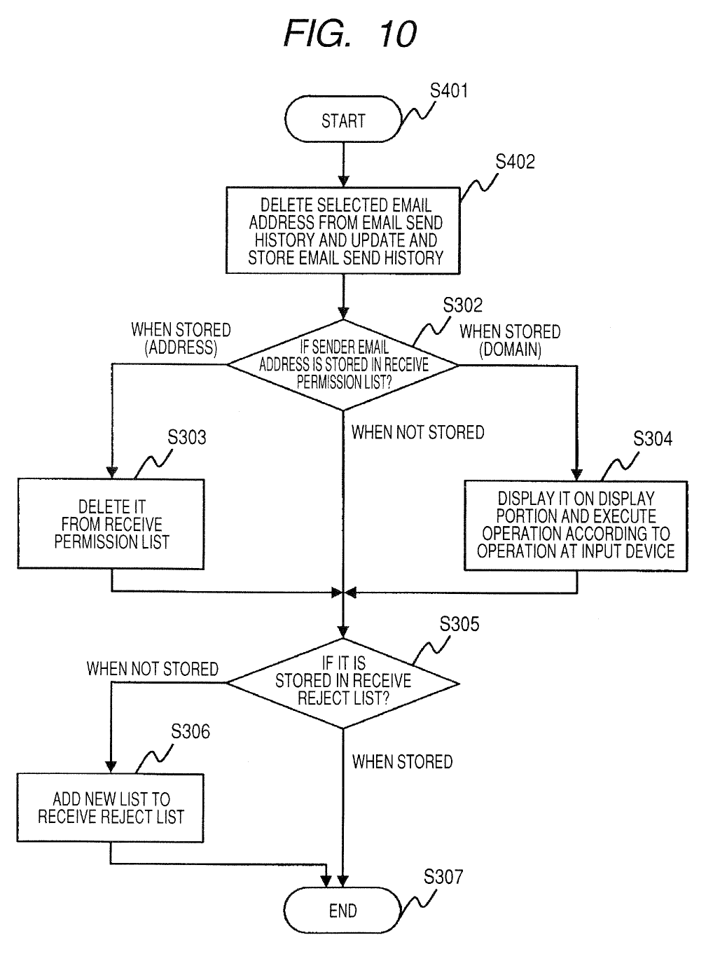

FIG. 10 shows a flow chart of an operation in which the email send and receive portion 21 deletes the specified email address of the email address send history 22b from the email address send history 22b, and updates and stores the receive permission list 22c and/or receive reject list 22d in such a manner not to receive an email having the deleted email address as the sender thereof.

This operation is similar to the above-mentioned operation in which the email send and receive portion 21 updates and stores the receive permission list 22c and/or receive reject list 22d in such a manner that an email transmitted from the email address of the sender of the displayed email entity 22a should not be received. Thus, the same operations thereof are given the same designations and the description thereof is omitted here.

The email send and receive portion 21 starts an operation not only to delete an email address from the email send history 22b but also to update and store the receive permission list 22c and/or receive reject list 22d in such a manner that an email having the deleted email address as the sender thereof will not be received (Step S401). And, email send and receive portion 21 allows the display portion 15 to display thereon an email address contained in the email send history 22b. Also, according to a given key operation at the input device 16, when the displayed email address is selected, the email send and receive portion 21 deletes the selected email address from the email send history 22b, thereby updating and storing the receive permission list 22c and/or receive reject list 22d (Step S402).

A blank line in the email send history 22b shown in FIG. 3 points out a position where the deleted email address was stored, but this is not limitative. The blank line may also be moved to a position where the destination email address of an email transmitted in the farthest past was stored.

Next, the email send and receive portion 21 updates and stores the receive permission list 22c and/or receive reject list 22d in such a manner that an email transmitted from the email address of the sender of the email entity 22a processed in the above-mentioned step S302 and its following steps will not be received. By the way, the email address of the sender of the email entity 22d in the above-mentioned description provides the selected email address in the present operation.

Since the number of email addresses to be stored in the email send history 22b is limited, the above-mentioned deletion of the email address from the email send history 22b is a processing necessary to delete an unnecessary email address and newly store a useful email address. Especially, such deletion is useful when the user of the unit determines that the user will not transmit any email to the deleted email address.

Effects, which are obtained by updating and storing the receive permission list 22c and/or receive reject list 22d in linking with the deletion of the email address in the email send history 22b, are as follows. That is, an email having an email address stored in the email send history 22b as the sender thereof, as has been already described, will be received with no direct operation of the user of the unit.

Thus, when the user transmits an email, if the user determines that the user will not receive an email having the destination thereof as the sender thereof, it is the easiest operation for the user of the unit to update and store the email send history 22b. That is, this operation is easier than an operation to edit the receive permission list 22c and receive reject list 22d, which will be discussed later.

The reason for this is as follows. In the email send history 22b, there are stored only the destination email addresses of emails transmitted in the near past, and the number of email addresses to be stored is limited. Thus, most of the stored email addresses are left in the memory of the user of the unit. This avoids the possibility that the user can be confused.

Next, description will be given below of an operation in which the permission and reject list edit portion 23 updates and stores the receive permission list 22c. The permission and reject list edit portion 23, according to a given key operation at the input device 16, updates and stores the receive permission list 22c and receive reject list 22d.

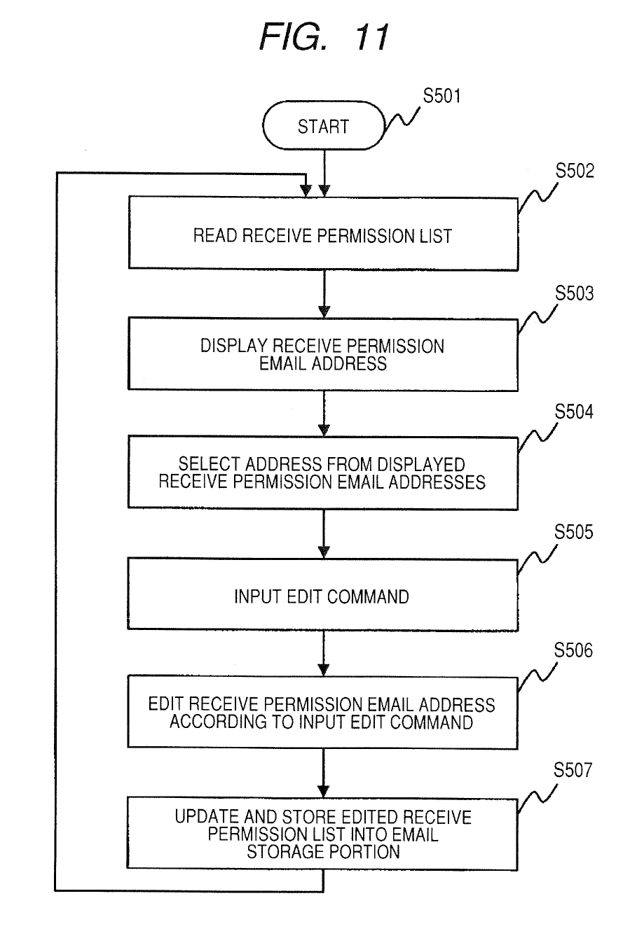

FIG. 11 shows a flow chart of an operation in which the permission and reject list edit portion 23 updates and stores the receive permission list 22c. The permission and reject list edit portion 23 starts its operation according to an instruction from the control portion 11 based on a given key operation at the input device 16 (Step S501). And, the permission and reject list edit portion 23 reads the receive permission list 22c (Step S502).

Here, the class 22m and receive permission email address 22n to be read are decided according to a given key operation at the input device 16, and they are any one of the following six types. That is, a first type is all of the classes 22m and receive permission email addresses 22n that are contained in the receive permission list 22c. A second type is the class 22m and receive permission email address 22n that are obtained by retrieving them under the retrieval condition that the class 22m is “history”.

A third type is the class 22m and receive permission email address 22n that are obtained by retrieving them under the retrieval condition that the class 22m is “edit”. A fourth type is the class 22m and receive permission email address 22n that are obtained by retrieving them under the retrieval condition that the class 22m is “history” and “edit” (in FIG. 4, this is shown as “history, edit”.

A fifth type is the class 22m and receive permission email address 22n that are obtained by retrieving them under the retrieval condition that the class 22m is neither “history” nor “history and edit”. A sixth type is the class 22m and receive permission email address 22n that are obtained by retrieving them under the retrieval condition that the class 22m is neither “edit” nor “history and edit”.

By selecting any one of these six types according to a given key operation at the input device 16, the user of the unit, firstly, can display all of the receive permission email addresses 22n and, secondly, can display the receive permission email addresses 22n based on the email send history 22b. Also, thirdly, the user of the unit can display the receive permission email addresses 22n based on the permission and reject list edit portion 23.

Fourthly, the user can display the receive permission email addresses 22n that are based not only on the email send history 22b but also on the operation of the permission and reject edit portion 23. Fifthly, the user can display the receive permission email addresses 22n based only on the operation of the permission and reject list edit portion 23; and, sixthly, the user can display the receive permission email addresses 22n based only on the email send history 22b.

Next, the permission and reject list edit portion 23 allows the display portion 15 to display thereon the receive permission email address 22n of the receive permission list 22c read (Step S503). Here, there may also be displayed the class 22m of the receive permission list 22c read. Also, when all of the receive permission email addresses 22n read cannot be displayed on the display portion 15 due to the limit of the screen of the display portion 15, the permission and reject list edit portion 23 displays some of them and, according to the operation of a given scroll key at the input device 16, scrolls the displayed addresses.

And, the permission and reject list edit portion 23, according to the operation of a given key at the input device 16, selects one or more from the displayed receive permission mail addresses 22n (Step S504) and, according to the operation of a given key at the input device 16, inputs an edit command with respect to the selected receive permission email address 22n (Step S505). Here, the edit command includes at least three types of operations, that is, a delete operation, a change operation and a new registration operation. By the way, when the command is the new registration operation, it is not necessary to carry out the select operation of the receive permission email address 22n in Step S504. Further, it is not always necessary to execute the display of the email addresses in Step S503.

Then, the permission and reject list edit portion 23 edits the receive permission email address 22n selected according to the edit command input therein (Step S506), allows the email storage portion 22 to update and store therein the edited receive permission email address 22n as the receive permission list 22c (Step S507), and moves to an operation to read the receive permission list 22c in Step S502.

Now, description will be given below of the class 22m that is stored while it is related to the edited receive permission email address 22n in Step S506. This class 22m is decided by the class 22m stored related to the receive permission email address 22n before edited and by the edit command. When the class 22m before edited is “edit”, and when the edit command is the new registration operation, the class 22m to be stored is “edit”.

When the class 22m before edited is “history” or [“history” and “edit”, and the edit command is the change operation, the class 22m to be stored is [“history” and “edit”]. When the edit command is the delete operation, of course, the class 22m is not stored. When the class 22m to be stored is set in this manner, the user of the unit, by referring to the reason why an electronic permission email address 22n, can determine easily whether it is proper that such receive permission email address 22n is contained in the receive permission list 22c or not.

By the way, the permission and reject list edit portion 23, in an arbitrary operation step, ends the operation to update and store the receive permission list 22c according to the operation of a given key at the input device 16 (the operation ending processing is not shown).

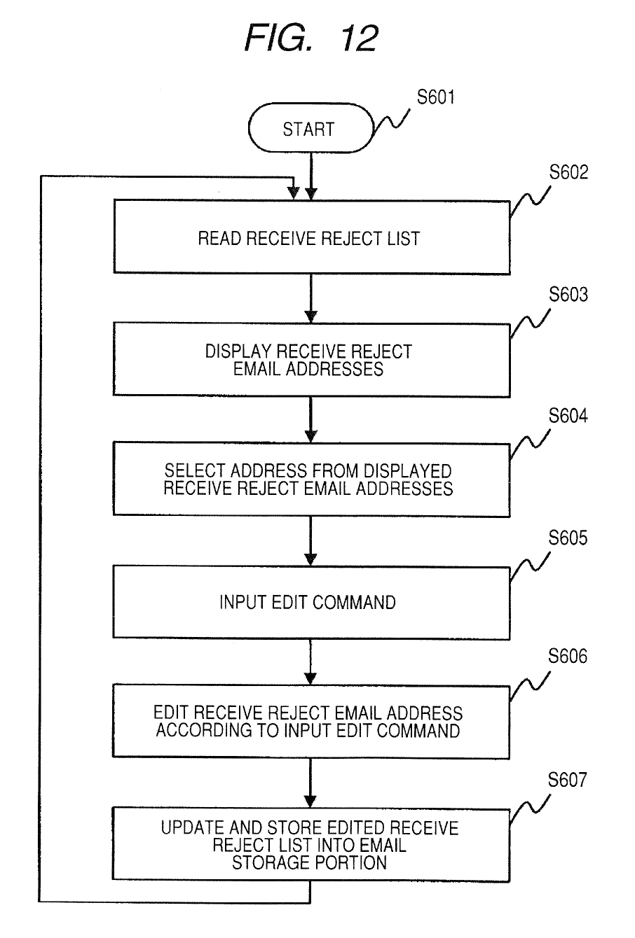

FIG. 12 shows a flow chart of an operation in which the permission and reject list edit portion 23 updates and stores the receive reject list 22d. The permission and reject list edit portion 23 starts the operation according to an instruction from the control portion 11 based on the operation of a given key at the input device 16 (Step S601). And, the permission and reject list edit portion 23 reads the receive reject list 22d (Step S602).

Here, the class 22p and receive reject email address 22q to be read are decided according to the operation of a given key at the input device 16 when the permission and reject list edit portion 23 starts the operation, and they are one of the following six types. Specifically, a first type is all of the classes 22p and receive reject email addresses 22q that are contained in the receive reject list 22d. A second type is the class 22p and receive reject email addresses 22q that are obtained by retrieval under the retrieval condition that the class 22p is “receive”.

A third type is the class 22p and receive reject email addresses 22q that are obtained by retrieval under the retrieval condition that the class 22p is “edit”. A fourth type is the class 22p and receive reject email addresses 22q that are obtained by retrieval under the retrieval condition that the class 22p is “receive” and “edit” (in FIG. 5, it is shown as “receive, edit”).

A fifth type is the class 22p and receive reject email addresses 22q that are obtained by retrieval under the retrieval condition that the class 22p is neither “receive” nor [“receive” and “edit”]. A sixth type is the class 22p and receive reject email addresses 22q that are obtained by retrieval under the retrieval condition that the class 22p is neither “edit” nor [“receive” and “edit”].

By selecting one of these six types according to the operation of a given key at the input device 16, the user of the unit firstly can display all of the receive reject email addresses 22q and secondly can display the receive reject email address 22q that is based on the sender's email address of an email received. And, thirdly, the user can display the receive reject email address 22q that is based on the operation of the permission and reject list edit portion 23.

Further, fourthly, the user can display the receive reject email address 22q that is based not only on the sender's email address of an electric mail received but also on the operation of the permission and reject list edit portion 23. Also, fifthly, the user can display the receive reject email address 22q that is based only on the operation of the permission and reject list edit portion 23. Sixthly, the user can display the receive reject email address 22q that is based only on the sender's email address of an electric mail received.

After then, the permission and reject edit portion 23 allows the display portion 15 to display thereon the receive reject email address 22q of the receive reject list 22d read (Step S603). Here, the class 22p of the receive reject list 22d read may also be displayed. Also, when all of the receive reject email addresses 22q read cannot be displayed on the display portion 15 due to the restriction of the display screen of the display portion 15, the permission reject list edit portion 23 allows the display portion 15 to display some of the receive reject email addresses 22q and scrolls the displayed addresses 22q according to the operation of a given key at the input device 16.

And, the permission and reject list edit portion 23 selects one or more of the displayed receive reject email addresses 22q according to the operation of a given key at the input device 16 (Step S604), and inputs an edit command for the thus selected receive reject email address (or addresses) 22q according to the operation of a given key at the input device 16 (Step S605). Here, the edit command includes at least three operations namely, a delete operation, a change operation and a new registration operation. When this command is the new registration operation, it is not necessary to carry out the select operation of the receive reject email address 22q in Step S604. Also, it is not always necessary to execute the operation to display the email address in Step S603.

The permission list edit portion 23 edits the receive reject email address 22q selected according to the input edit command (Step S606), allows the email storage portion 22 to update and store the thus edited receive reject email address 22q as the receive reject list 22d (Step S607), and moves to an operation to read the receive reject list 22d in Step S602.

Now, description will be given below of the class 22p that is stored while it is related to the edited receive reject email address 22q in Step S606. This class 22p is decided by the class 22p stored related to the receive reject email address 22q before edited and by the edit command. When the class 22p before edited is “edit”, and when the edit command is the new registration operation, the class 22p to be stored is “edit”.

When the class 22p before edited is “receive” or [“receive” and “edit”], and when the edit command is the change operation, the class 22p to be stored is [“receive” and “edit”]. When the edit command is the delete operation, of course, the class 22p is not stored. Thus, when the class 22p to be stored is set in this manner, the user of the unit, by referring to the reason why the receive reject email address 22q has been stored, can determine easily whether it is proper that such receive reject email address 22q is contained in the receive reject list 22d or not.

The permission and reject list edit portion 23, in an arbitrary operation step, according to the operation of a given key at the input device 16, ends the operation to update and store the receive reject list 22d (this ending operation is not shown).

Referring further to the above description, since the email send and receive portion 21 receives an email having the destination email address of the email transmitted as the sender thereof, when the email send and receive portion 21 inputs such email address into the receive permission list 22c, if the domain name of such email address and a portion of such domain name is stored in the receive permission email address 22n, the email send and receive portion 21 does not store such email address into the receive permission email address 22n (see the operation of the step S122 in the flow chart shown in FIG. 7).

However, this is not limitative. The email send and receive portion 21 may also store such email address into the receive permission email address 22. Although to store the domain name of such email address or a portion of such domain name and such email address incurs an increase in the storage capacity necessary for storage, even when the domain name of such email address is deleted by the permission and reject list edit portion 23, it is easy to set the condition for receiving of an email having such email address as the sender thereof.

In the above description, the email send and receive portion 21, when determining whether it receives an email or not, firstly, refers to the receive permission list 22c and next refers to the receive reject list 22d (see the operations respectively to be executed in Steps S203 and S206 shown in FIG. 8). This reference sequence is effective especially when storing the email address in the receive permission list 22c and storing the domain name or a portion of the domain name in the receive reject list 22d.

That is, the above reference sequence is suitable for a processing in which, while, in principle, the email send and receive portion 21 will not receive an email with an email address having a certain domain name or a portion of the domain name as the sender thereof, the portion 21 will receive an email with a partial address of an email address having such domain name or a portion of such domain name as the sender thereof.

Alternatively, when the email send and receive portion 21 determines whether an email should be received or not, reversely to the above, it may firstly refer to the receive reject list 22d and next may refer to the receive permission list 22c. This reference sequence is effective especially when an email address is stored in the receive reject list 22d and a domain name or a portion of the domain name is stored in the receive permission list 22c.

That is, the above reference sequence is suitable for a processing in which, while, in principle, the email send and receive portion 21 will receive an email with an email address having a certain domain name or a portion of the domain name as the sender thereof, the portion 21 will not receive an email with a partial address of an email address having such domain name or a portion of such domain name as the sender thereof.

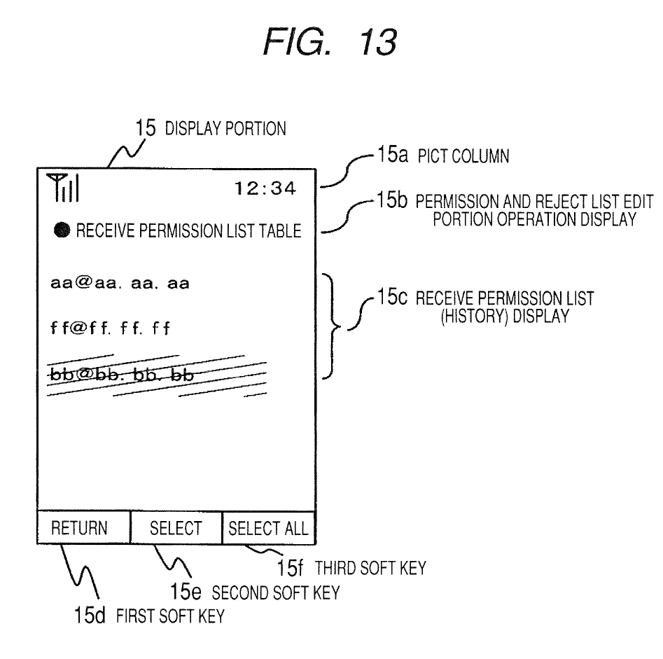

Here, there are shown some examples of the display of the display portion 15 to be carried out by the email send and receive portion 21 and the display of the display portion 15 to be carried out by the permission and reject list edit portion 23. FIG. 13 shows an example of the display of the display portion 15 to be executed by the permission and reject list edit portion 23. Specifically, this is an example of the display which is executed while editing an email address, namely, the receive permission email address 22n including “history” as the class 22m that is stored in a related manner (see the operation of Step S503 in the flow chart shown in FIG. 11).

This display includes: a PICT column 15a displayed on the upper-most line of the display portion 15; a permission and reject list edit portion operation display 15b displayed below of the PICT column 15a; a receive permission list (history) display 15c displayed in the central portion of the display portion 15; and, a first soft key 15d, a second soft key 15e, and a third soft key 15f displayed on the lower-most line of the display portion 15 in such a manner that they are arranged from left to right respectively in this order.

The PICT column 15a includes: a figure, which includes an antenna-shaped line drawing and vertical rods expressing the intensity of radio waves transmitted from a base station from which the unit receives an email; and, time. The time is shown as [12:34], that is, twelve o'clock thirty four minutes. The permission and reject list edit portion operation display 15b expresses what operation the permission and reject list edit portion 23 is carrying out, that is, expresses that the permission and reject list edit portion 23 is editing the receive permission list 22c; and, this is shown as [•receive permission list table].

In the receive permission list (history) display 15c, there are displayed email addresses which are the receive permission email addresses 22n shown in FIG. 4 and include “history” as the class 22m stored in a related manner. In one or more of these displayed addresses, there is provided a cursor and, as will be discussed later, the address with the cursor provided therein is a target to be selected. Specifically, the cursor is provided in an address [bb@bb.bb.bb], and the provision of the cursor is shown by hatchings.

In the first soft key 15d, there is displayed “return”. This shows the following operation: that is, according to the operation of a key at the input device 16 disposed at a position near to the first soft key 15d, the permission and reject list edit portion 23 returns to the operation of the permission and reject list edit portion 23 that is to be executed just before the display shown in FIG. 13 is carried out.

In the second soft key 15e, there is displayed “select”. This shows the following operation: that is, according to the operation of a key at the input device 16 disposed at a position near to the second soft key 15e, the permission and reject list edit portion 23b selects the address that the cursor is provided in. By the way, after selected, the selected address, for example, is deleted or edited.

In the third soft key 15f, there is displayed “all select”. This shows the following operation: that is, according to the operation of a key at the input device 16 disposed at a position near to the third soft key 15f, the permission and reject list edit portion 23 selects all of the addresses displayed.

By the way, the display of the PICT column 15a is always displayed in the upper-most line of the display portion 15 whether the email send and receive portion 21 is in operation or the permission and reject list edit portion 23 is in operation. Thus, description of the operations to be executed after then is omitted. Also, all or some of the first soft key 15d, second soft key 15e and third soft key 15f are also always displayed on the lower-most line of the display portion 15. Thus, description will be given below of the different points of this example from the previously discussed example.

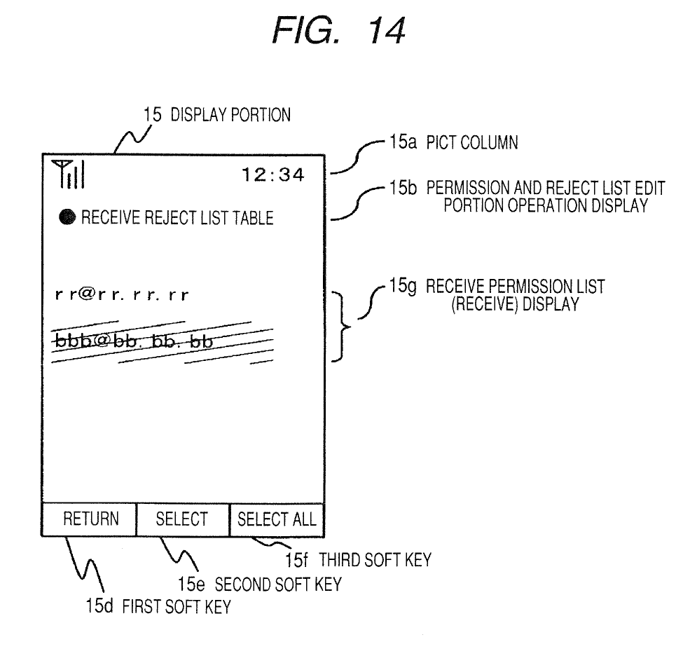

FIG. 14 shows an example of the display of the display portion 15 that is carried out by the permission and reject list edit portion 23 and, specifically, this shows an example of the display of the display portion 15 to be executed while editing an email address that is the receive reject email address 22q shown in FIG. 5 and includes “receive” as the class 22m stored in a related manner (see the operation of the step S603 of the flowchart shown in FIG. 12). By the way, this is similar to the example of the display of the email address that is the receive permission email address 22n described above with reference to FIG. 13 and includes “history” as the class 22m stored in a related manner. Thus, the same displays thereof are given the same designations and the description thereof is omitted here.

The permission and reject list edit portion operation display 15b expresses that the permission and reject list edit portion is editing the receive reject list 22d, which is shown as [•receive reject list table] in FIG. 14. Also, in the central portion of the display portion 15, instead of the display of the receive permission list (history) display 15c shown in FIG. 13, there is displayed a receive reject list (receive) display 15g.

The receive reject list (receive) display 15g displays the email addresses that are the receive reject email addresses 22q shown in FIG. 5 and each include “receive” as the related class 22p. In one or more of these displayed addresses, there is provided a cursor.

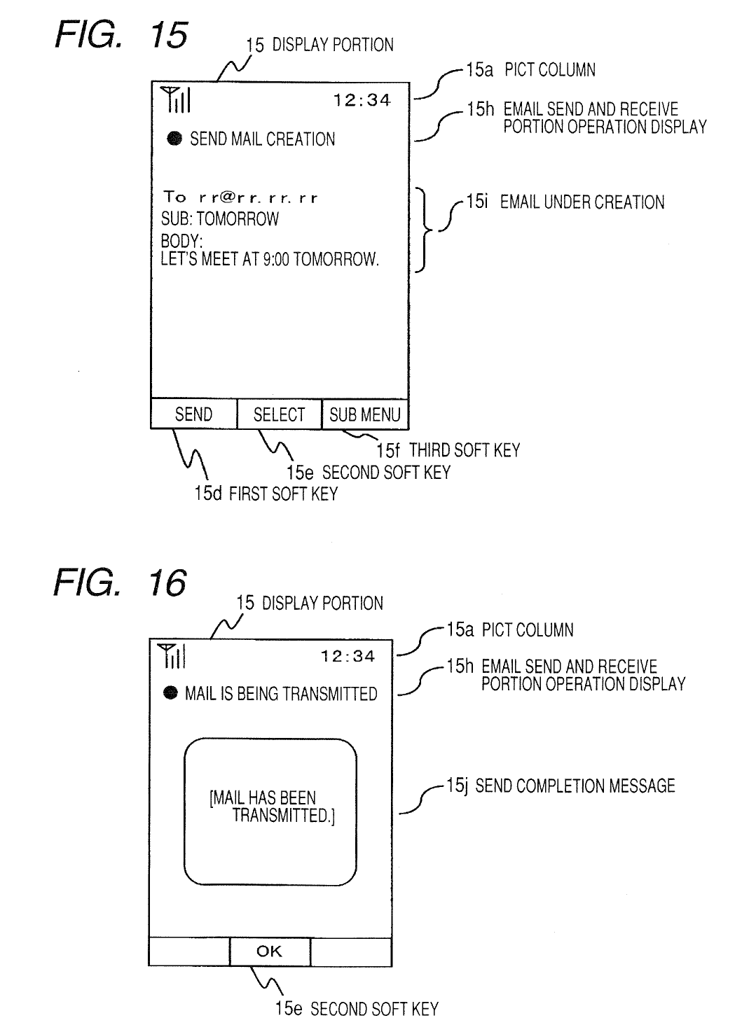

FIG. 15 shows an example of a display to be displayed on the display portion 15 while the email send and receive portion 21 is creating an email (see the operation of the step S106 of the flowchart shown in FIG. 6). In the email send and receive portion operation display 15h that is displayed below the PICT column 15a, there is shown a message [• send mail is under creation].

In the central portion of the display portion 15, there is displayed an email 15i which is being created. This display includes three items, that is, the destination email address (To: [rr@rr.rr.rr], subject (Sub: tomorrow) and body (Let's meet at 9:00 tomorrow) of the email.

On the first soft key 15d, there is displayed “send”, expressing that the email send and receive portion 21 sends the created email according to the operation of a key at the input device 16 disposed at a position near to the first soft key 15d.

On the second soft key 15e, there is displayed “select”, expressing that, according to the operation of a key at the input device 16 disposed at a position near to the second soft key 15e, the email send and receive portion 21 moves to an operation to edit an item which is one of the three items, namely, destination email address, subject and body and also in which a cursor (not shown) is provided.

In a third soft key 15f, there is displayed “sub menu”, expressing that, according to the operation of a key at the input device 16 disposed at a position near to the third soft key 15f, the email send and receive portion 21 displays a sub menu involved with the creation of the send mail.

FIG. 16 shows an example of the display to be displayed on the display portion 15 when an email is being transmitted by the email send and receive portion 21 (see the operation of the step S107 of the flow chart shown in FIG. 16). This is shown as [• mail is being transmitted] in the email send and receive portion operation display 15h that is displayed below the PICT column 15a. Also, in the central portion of the display portion 15, there is displayed a send completion message 15j telling to the effect that [mail has been transmitted].

Also, in a second soft key 15e, there is displayed “OK”, expressing that, according to the operation of a key at the input device 16 disposed at a position near to the second soft key 15e, the email send and receive portion 21 ends the display of the send completion message 15j and moves to, for example, an operation to create and send a different mail.

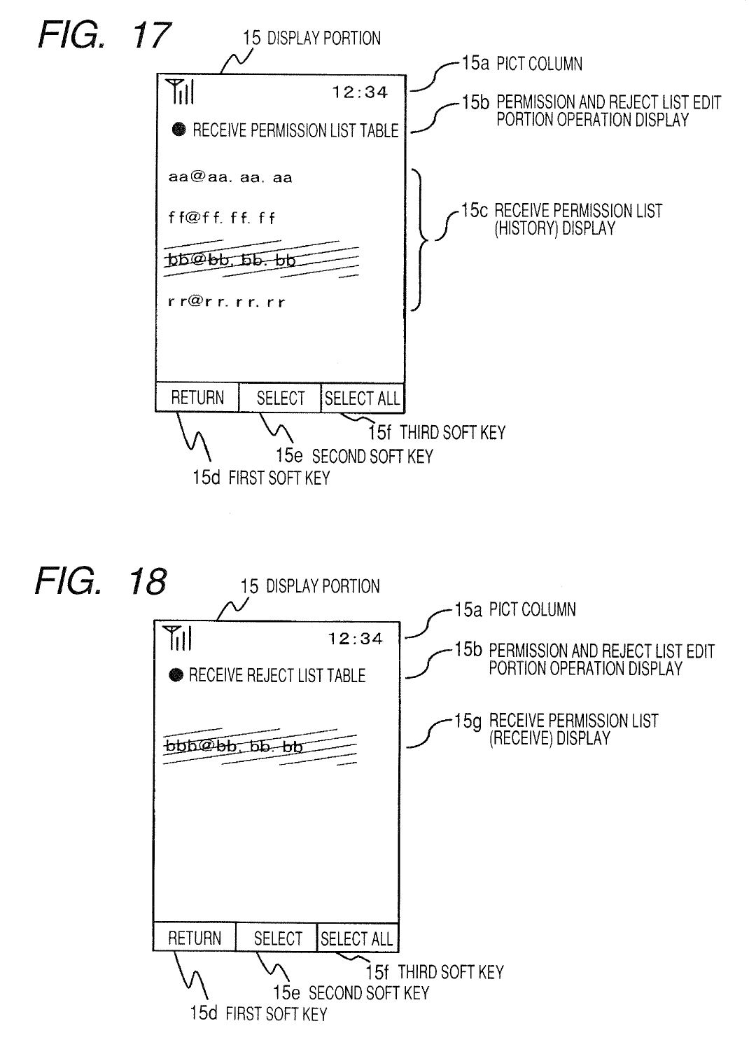

After, as has been described with reference to FIGS. 15 and 16, the email send and receive portion 21 has transmitted the email to the destination email address [rr@rr.rr.rr], the permission and reject list edit portion 23 allows the display portion 15 to display some messages, two examples of which will be discussed below. Firstly, FIG. 17 shows the display example that is carried out while editing an email address which is the receive permission email address 22n and includes “history” as the class 22m stored in a related manner.

The display example shown in FIG. 17 is similar to the display example of the display portion 15 previously shown in FIG. 13 and carried out by the permission and reject list edit portion 23. Thus, description will be given here of the points of the present display example thereof that are different from the previously shown display example. To the receive permission list (history) display 15c, when compared with the example shown in FIG. 13, there is added an email address [rr@rr.rr.rr]. This shows that the present email address has been added to the receive permission list 22c according to the email send history 22b (see the operation of the step S126 of the flow chart shown in FIG. 7).

Next, FIG. 18 shows an example of a display to be made while editing the email address that is the receive reject email address 22q and includes “receive” as the relatedly stored class 22m.

The display example shown in FIG. 18 is similar to the display example already shown in FIG. 14 and made by the permission and reject list edit portion 23 and thus description will be given below of the differences of the present display from the previously described display. In the receive reject list (receive) display 15, when compared with the example shown in FIG. 14, there is not displayed the email address [rr@rr.rr.rr]. This means that this email address has been deleted from the receive reject list 22d according to the email send history 22b (see the operation of the step S127 of the flow chart shown in FIG. 7).

### Second Embodiment

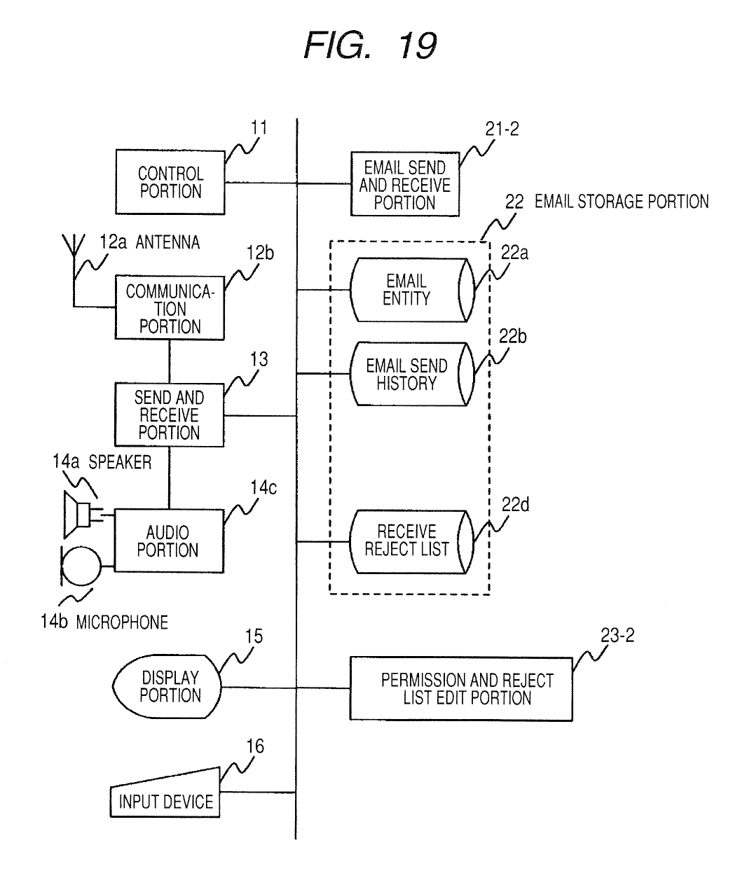

FIG. 19 is a block diagram of the structure of a mobile communication terminal unit to which a communication apparatus according to a second embodiment is applied.

This mobile communication terminal unit is similar to the mobile communication terminal unit according to the first embodiment. Therefore, the same parts thereof are given the same designations and thus the description thereof is omitted here, while description will be given below of those of the present embodiment that are different from the first embodiment. That is, the mobile communication terminal unit according to the second embodiment, when compared with the mobile communication terminal unit according to the first embodiment, includes an email send and receive portion 21-2 instead of the email send and receive portion 21, and a permission and reject list edit portion 23-2 instead of the permission and reject list edit portion 23. And, in the email storage portion 22, there is not stored the receive permission list 22c.

Now, description will be given below of the points of the operation of the email send and receive portion 21-2 that are different from the operation of the email send and receive portion 21. The email send and receive portion 21-2, in any one of the operations thereof, refers to the receive permission list 22c but does not carry out an operation to store the receive permission list 22c.

Firstly, description will be given of the difference of the email send and receive portion 21-2 when it transmits an email. The email send and receive portion 21-2, according to the stored receive reject list 22d, carries out an operation to update and store the receive reject list 22d in the following manner. This is the operation that is shown in the step S109 of the flow chart shown in FIG. 6 so as to allow the receiving of an email having an email address stored in the email send history 22b as the sender thereof.

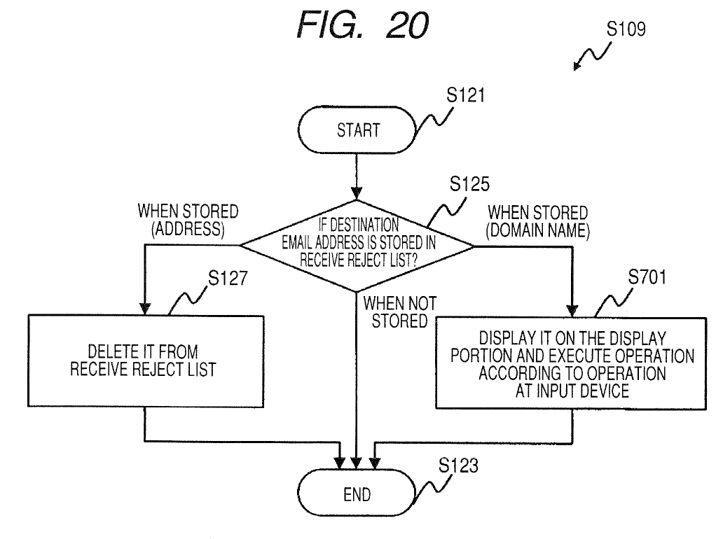

FIG. 20 shows a flow chart of the operation of the email send and receive portion 21-2 to update and store the receive reject list 22d as shown in Step S109. This is similar to the operation of the step S109 to be carried out by the email send and receive portion 21 according to the first embodiment. Therefore, the same operation steps are given the same designations and thus the description thereof is omitted here.

The email send and receive portion 21-2, after start of the operation of a step S121, checks in Step S125 whether a destination email address is stored in the receive reject email address 22q of the receive reject list 22d or not. When stored, the email send and receive portion 21-2 moves to an operation to check whether the destination email address is stored as the receive reject email address 22q or not and whether the domain name of the destination email address or a portion of such domain name is stored or not.

When the destination email address is not stored as the receive reject email address 22q, the email send and receive portion 21-2 moves to an operation to end the updating and storing operation of the step S123. When the destination email address is stored as the receive reject email address 22q, the email send and receive portion 21-2 moves to an operation shown in Step S127 to delete the receive reject list 22d in which the receive reject email address 22q is the destination email address.

When the domain name of the destination email address or a portion of the domain name is stored as the receive reject email address 22q, the email send and receive portion 21-2 allows the display portion 15 to display a message telling that effect thereon, carries out an operation according to the operation of a given key at the input device 16 (Step S701), and then moves to an operation to end the updating and storing operation shown in Step S123.

As operations to be carried out in this step S701, there are at least three available choices as follows. That is, as a first choice, the email send and receive portion 21-2 deletes the receive reject list 22d in which the receive reject email address 22q is the domain name thereof or a portion of such domain name. As a second choice, the email send and receive portion 21-2 updates the receive reject list 22d.

As a third choice, the email send and receive portion 21-2 deletes the receive reject list 22d in which the receive reject email address 22q is the domain name thereof or a portion of such domain name, and selects an email address that is the sender's email address of the email entity 22a and also is the receive reject email address 22q of the receive permission list 22c in which the domain name of such address or a portion of such domain name is deleted. And, the email send and receive portion 21-2 additionally stores the receive reject list 22d in which the selected email address is used as the receive reject email address 22q and “edit” is used as the class 22p.

By the way, when such email address is stored and the domain name of such email address or a portion of such domain name is stored, the email send and receive portion 21-2, after execution of the operation in Step S127, carries out the operation in Step S701 (not shown).

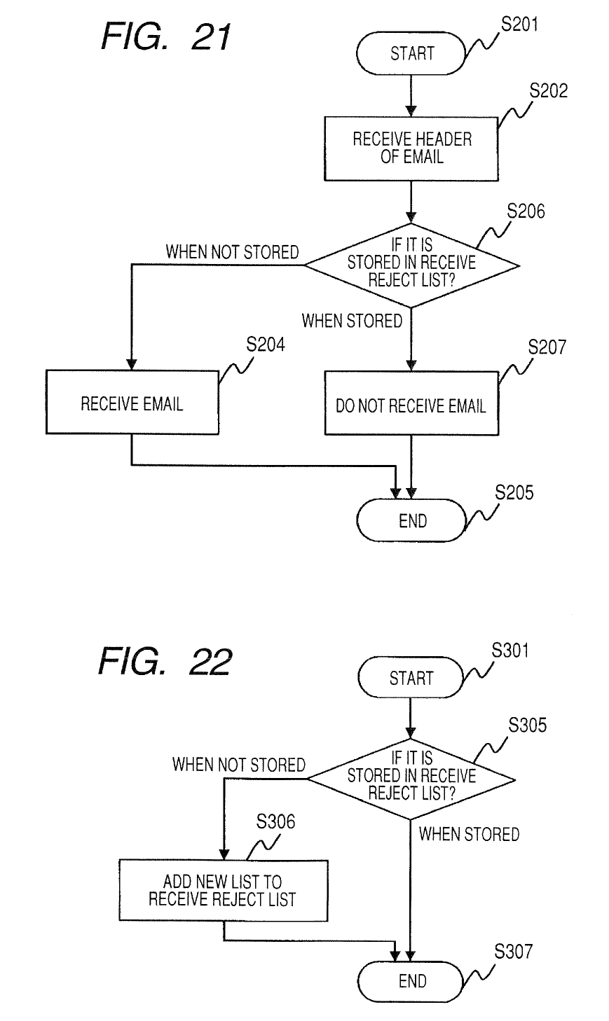

Next, description will be given below of different points found when the email send and receive portion 21-2 receives an email. The email send and receive portion 21-2, when receiving an email, checks according to the sender electronic air mail address of this email whether it should receive this email or not. FIG. 21 shows a flow chart of an operation in which the email send and receive portion 21-2 receives an email.

This operation is similar to the operation which has been described with reference to the flow chart shown in FIG. 8 in which the email send and receive portion 21 according to the first embodiment receives an email. Therefore, the same operation steps are given the same designations and thus the description thereof is omitted here.

Specifically, the email send and receive portion 21-2, after receiving the header of the email in Step S202, moves to an operation in which it checks whether the sender's email address of the email in Step S206 is stored as the receive reject email address 22q in the receive reject list 22d or not.

Next, description will be given below of an operation in which the email send and receive portion 21-2 allows the display portion 15 to display the email entity 22a, and updates and stores the receive reject list 22d in order that an email transmitted from the email address of the sender of the thus displayed email entity 22a will not be received.

FIG. 22 shows a flow chart of the operation in which the email send and receive portion 21-2 updates and stores the receive reject list 22d in order that an email transmitted from the email address of the sender of the thus displayed email entity 22a should not be received.

This operation is similar to the operation which has been already described with reference to the flow chart shown in FIG. 9 and in which the email send and receive portion 21 according to the first embodiment updates and stores the receive permission list 22c and/or the receive reject list 22d in order that an email transmitted from the email address of the sender of the email entity 22a should not be received. Therefore, the same operation steps are given the same designations and thus the description thereof is omitted.

Specifically, the email send and receive portion 21-2, after start of the operation in Step S301, moves to an operation in which it checks whether the email address of the sender in Step S305 is stored as the receive reject email address 22q in the receive reject list 22d or not.

Next, description will be given below of an operation in which the email send and receive portion 21-2 deletes the email address of the email send history from the email send history 22b, and also updates and stores the receive reject list 22d in order that an email having the thus deleted email address as the sender thereof will not be received.

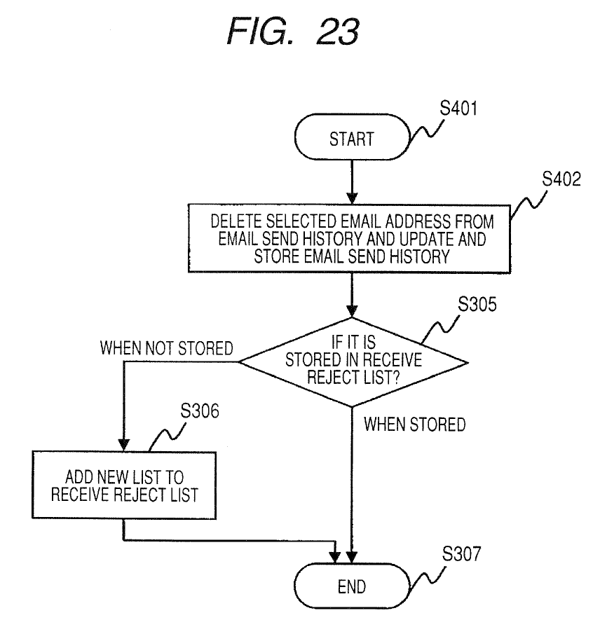

FIG. 23 shows a flow chart of an operation in which the email send and receive portion 21-2 deletes the email address of the email send history from the email send history 22b, and also updates and stores the receive permission list 22c and/or the receive reject list 22d in order that an email having the thus deleted email address as the sender thereof will not be received.

This operation is similar to the operation which has been already described with reference to the flow chart shown in FIG. 10 and in which the email send and receive portion 21 according to the first embodiment deletes the email address of the email send history 22b from the email send history 22b, and also updates and stores the receive permission list 22c and/or the receive reject list 22d in order that an email having the deleted email address as the sender thereof will not be received. Therefore, the same operation steps are given the same designations and thus the description thereof is omitted here.

Specifically, the email send and receive portion 21-2, after end of the operation in Step S402, moves an operation in which it checks whether the email address of the above sender is stored as the receive reject email address 22q in the receive reject list 22d or not.

Next, description will be given below of the operation of a permission and reject list edit portion 23-2 and, specifically, the different points of the permission and reject list edit portion 23-2 from the permission and reject list edit portion 23. The permission and reject list edit portion 23-2 does not carry out the receive permission list 22c updating and storing operation which has been already described with reference to the flow chart shown in FIG. 11.

The mobile communication terminal unit according to the second embodiment, when compared with the mobile communication terminal unit according to the first embodiment, is structured such that the receive permission list 22c is not stored in the email storage portion 22; and, therefore, the storage capacity thereof can be reduced. Also, since the email send and receive portion 21-2 and permission and reject list edit portion 23-2 do not carry out the operation to refer to and store the receive permission list 22c, the processing of the second embodiment can be reduced.

### Third Embodiment

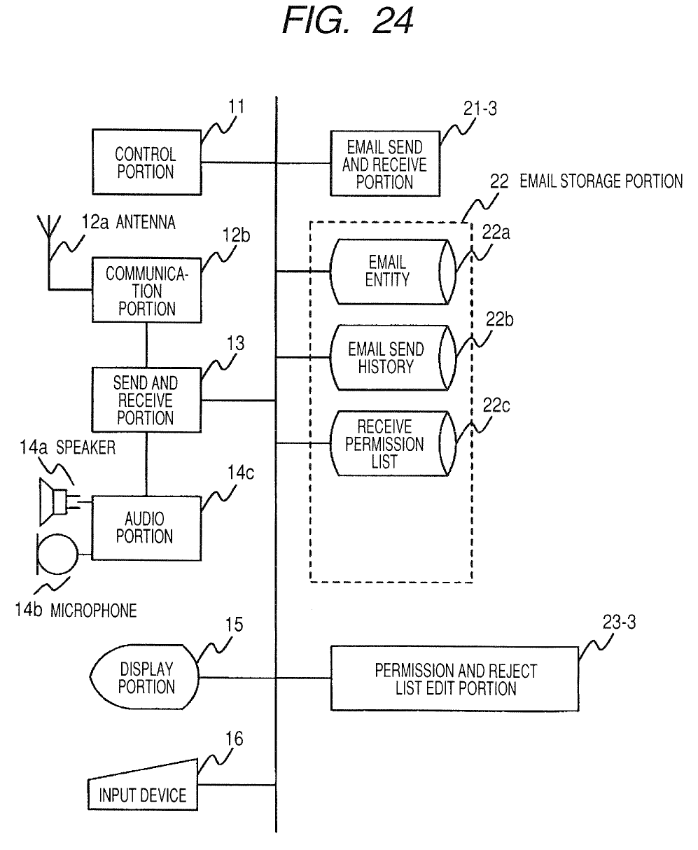

FIG. 24 is a block diagram of the structure of a mobile communication terminal unit to which a communication apparatus according to a third embodiment is applied.

This mobile communication terminal unit is similar to the mobile communication terminal unit according to the first embodiment. Therefore, the same portions thereof are given the same designations and thus the description thereof is omitted here. Description will be given below of the portions of the third embodiment that are different from those of the first embodiment. That is, this mobile communication terminal unit, when compared with the mobile communication terminal unit according to the first embodiment, includes an email send and receive portion 21-3 instead of the email send and receive portion 21, and a permission and reject list edit portion 23-3 instead of the permission and reject list edit portion 23. And, in the email storage portion 22, there is not stored the receive reject list 22d.

Description will be given below of the operation of the email send and receive portion 21-3 and, specifically, the different points thereof from the operation of the email send and receive portion 21. The email send and receive portion 21-3, in any one of the operations thereof, does not carry out the operation to refer to and store the receive reject list 22d.

Firstly, description will be given below of the differences between the third and first embodiments when the email send and receive portion 21-3 transmits an email. The email send and receive portion 21-3 carries out an operation in Step S109 of the flow chart shown in FIG. 6 in the following manner, in which it updates and stores the receive permission list 22c according to the stored receive permission list 22c in order that an email having an email address stored in the email send history 22b as the sender thereof will be received.

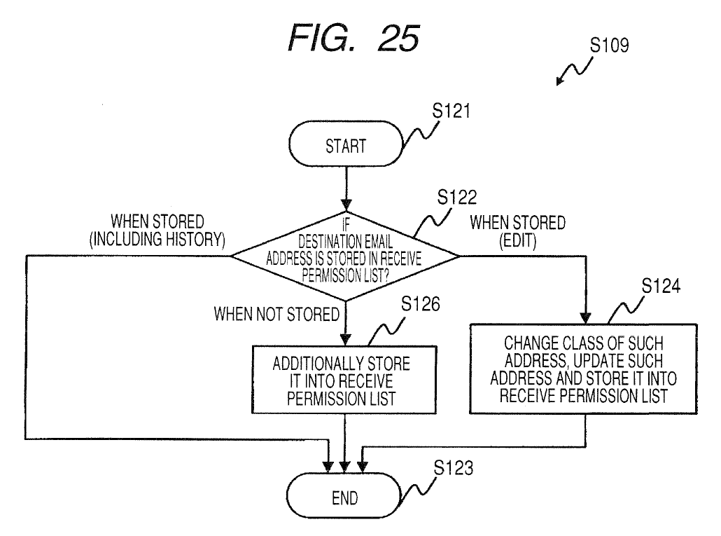

FIG. 25 shows a flow chart of the receive permission list 22c updating and storing operation to be carried out by the email send and receive portion 21-3. This operation is similar to the operation which has been already described with reference to the flow chart shown in FIG. 7, that is, the operation which is carried out by the email send and receive portion 21 according to the first embodiment in Step S109.

Specifically, the email send and receive portion 21-3 checks whether the destination email address in Step S122 is stored as the receive permission email address 22n of the receive permission list 22c or not. When stored, the email send and receive portion 21-3 obtains and checks a class 22m which is stored while it is related to such receive permission email address 22n. After then, when the destination email address is stored as the receive permission email address 22n and “history” is contained in the thus obtained class 22m, the email send and receive portion 21-3 moves to an ending operation in Step S123.

When the destination email address is stored as the receive permission email address 22n and the obtained class 22m is “edit”, the email send and receive portion 21-3 changes this class 22m to [“history” and “edit”] in Step S124, and moves to its updating and storing operation.

When the destination email address is not stored as the receive permission email address 22n, the email send and receive portion 21-3 moves to an operation in Step S126 in which it additionally stores into the receive permission list 22c a piece of related information not only having “history” as the class 22m but also having the receive permission email address 22n as the destination email address.

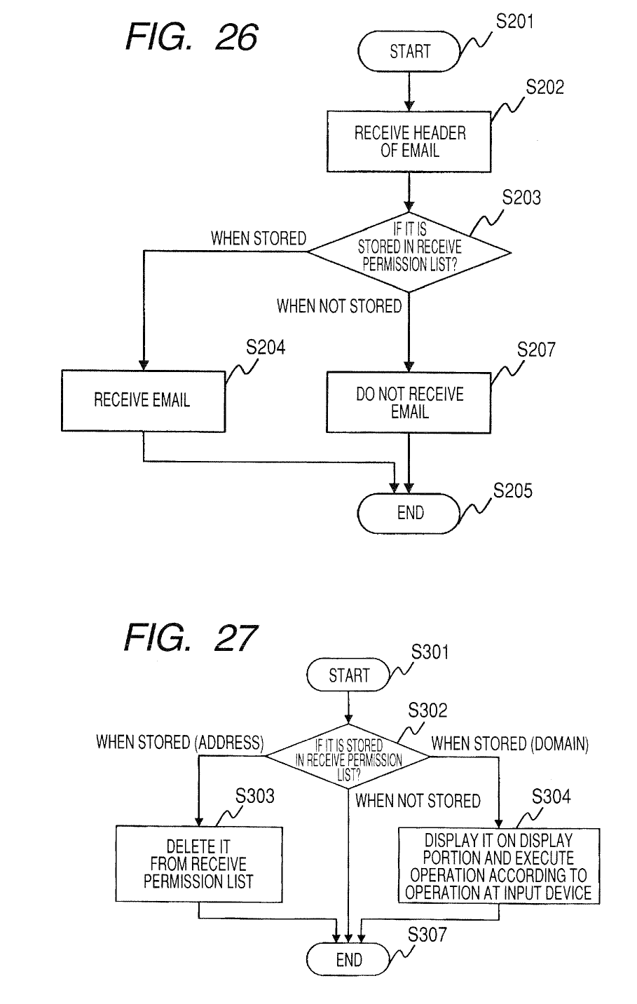

Next, description will be given below of different points between the third and first embodiment when the email send and receive portion 21-3 receives an email. The email send and receive portion 21-3, when receiving the email, carries out an operation including a determination according to the sender's email address of the email whether it should receive the email or not. FIG. 26 shows a flow chart of the operation of the email send and receive portion 21-3 when receiving an email.

This operation is similar to the email receiving operation of the email send and receive portion 21 according to the first embodiment which has been already described with reference to the flow chart shown in FIG. 8. Therefore, the same operation steps are given the same designations and thus the description thereof is omitted here.

The email send and receive portion 21-3 carries out an operation in Step S203 to check whether the sender's email address contained in the header received is stored as the receive permission email address 22n in the receive permission list 22c or not. After then, when stored, the email send and receive portion 21-3 moves to an operation in Step S204 to receive the email. On the other hand, when not stored, the email send and receive portion 21-3 moves to an operation in Step S207 not to receive the email.

Next, description will be given below of an operation in which the email send and receive portion 21-3 allows the display portion 15 to display the email entity 22a, and updates and stores the receive permission list 22c in order that an email transmitted from the email address of the sender of the displayed email entity 22a should not be received.

FIG. 27 shows a flow chart of an operation in which the email send and receive portion 21-3 updates and stores the receive permission list 22c in order that an email transmitted from the email address of the sender of the email entity 22a should not be received.

This operation is similar to the operation which has been already described with reference to the flow chart shown in FIG. 9, that is, the operation in which the email send and receive portion 21 according to the first embodiment updates and stores the receive permission list 22c and/or the receive reject list 22d in order that an email transmitted from the email address of the sender of the email entity 22a should not be received. Therefore, the same operation steps are given the same designations and thus the description thereof is omitted here.

When not stored in Step S302, when the operation in Step S303 is ended, and when the operation in Step S304 is ended, the email send and receive portion 21-3 moves to the ending operation in Step S307.

Next, description will be given below of an operation in which the email send and receive portion 21-3 deletes the email address of the email send history 22b from the email send history 22b as well as updates and stores the receive permission list 22c in order that an email having the deleted email address as the sender thereof should not be received.

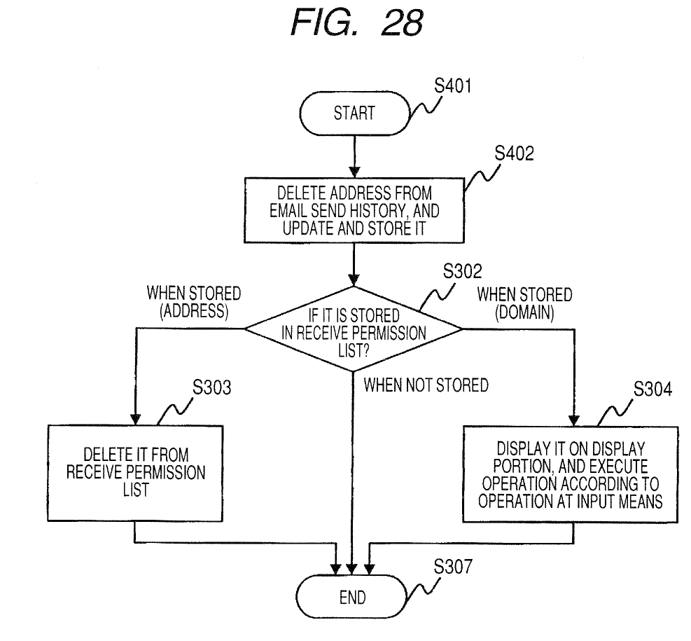

FIG. 28 shows a flow chart of an operation in which the email send and receive portion 21-3 deletes the email address of the email send history 22b from the email send history 22b as well as updates and stores the receive permission list 22c in order that an email having the deleted email address as the sender thereof should not be received.

This operation is similar to the operation that has been already described with reference to the flow chart shown in FIG. 10, that is, the operation in which the email send and receive portion 21 according to the first embodiment deletes the email address of the email send history 22b from the email send history 22b as well as updates and stores the receive permission list 22c and/or the receive reject list 22d in order that an email having the thus deleted email address as the sender thereof should not be received. Therefore, the same operation steps are given the same designations and thus the description thereof is omitted here.

When not stored in Step S302, when the operation in Step S303 is ended, and when the operation in Step S304 is ended, the email send and receive portion 21-3 moves to an ending operation in Step 5307.

Next, description will be given below of the portions of the operation of the permission and reject list edit portion 23-3 that are different from the operation of the permission and reject list edit portion 23. The permission and reject list edit portion 23-3 does not carry out the operation that has been already described with reference to the flow chart shown in FIG. 12, that is, the operation to update and store the receive reject list 22d.

According to the mobile communication terminal unit according to the third embodiment, when compared with the mobile communication terminal unit according to the first embodiment, in the email storage portion 22, there is not stored the receive reject list 22d. Therefore, the storage capacity of the email storage portion 22 can be reduced. Also, the email send and receive portion 21-3 as well as the permission and reject list edit portion 23-3 do not carry out the operation to refer to and store the receive reject list 22d, thereby being able to reduce the processing to be executed by them.

### Other Embodiments

In the foregoing description, the receive permission list 22c and receive reject list 22d are stored separately. However, this is not limitative but they may also be stored integrally. When they are stored integrally, there is further stored such information in a related manner that expresses whether an address is an address for receiving or an address against receiving.

Also, whether the address for receiving is stored such that it is checked first or the address against receiving is stored such that it is checked first, as has been already described, can be selected properly in correspondence to the referring sequence of the receive permission list 22c and receive reject list 22d to be referred to by the email send and receive portion 21, when checking whether it should receive an email or not.

When the mobile communication terminal unit includes email addresses and an address book (not shown) in which names corresponding to the email addresses are stored while they are related to each other, the respective portions of the unit, when allowing the display portion 15 to display the email addresses, may also allow the display portion 15 to display the names stored in the address book while they are related to their corresponding email addresses, instead of the email addresses, or in addition to the email addresses.

According to the foregoing description, the mobile communication terminal unit is structured such that an email corresponding to an email address and having the email address as the sender thereof is transmitted and an email having such email address as the destination thereof is received. However, this is not limitative but the mobile communication terminal unit may also correspond to a plurality of email addresses.

When the mobile communication terminal unit corresponds to a plurality of email addresses, the unit stores the respective pieces of related information to be stored into the email entity 22a, email send history 22b, receive permission list 22c and receive reject list 22d, together with the email addresses that correspond to the present unit and also relate to their respective corresponding pieces of information. Alternatively, the unit may also include email entities 22a, email send histories 22b, receive permission lists 22c and receive reject lists 22d which are respectively different from each other for their respective emails.

When the receive permission list 22c includes “edit” as the class 22m and the receive reject list 22d includes “edit” as the class 22p, they may also be structured such that they can be stored in common with respect to all email addresses corresponding to the present unit. In other words, when the receive permission list 22c includes “history” as the class 22m and the receive reject list 22d includes “receive” as the class 22p, they are stored separately with respect to the respective email addresses corresponding to the present unit.

The foregoing description has been given with reference to the examples in which the invention is applied to a mobile communication terminal unit. However, of course, the invention can also be applied to all types of apparatuses such as a personal computer which can be used to send and receive emails. Further, the invention can be applied to a mail server device. The mail server device allows a plurality of apparatuses to receive emails transmitted from a plurality of apparatuses. However, this processing is the same as the above-mentioned processing to be executed when the mobile communication terminal unit corresponds to a plurality of email addresses.

By the way, the email send and receive portions 21, 21-2, 21-3 as well as the permission and reject list edit portions 23, 23-2, 23-3 may also be composed of programs which can be operated using a computer. The invention is not limited to the above-mentioned structures but various changes are also possible.

What is claimed is:

1. A communication apparatus, comprising:
an input unit;
a storage unit;
an edit unit configured to control the storage unit to store an email address input according to a given operation at the input unit;
an email send unit configured to control the storage unit to store a destination address of an outgoing email; and
an email receive unit configured to receive a body of an incoming email when a sender's address of the incoming email is stored in the storage unit.

2. A communication apparatus, comprising:
an input unit;
a first storage unit;
a second storage unit;
an edit unit configured to control to allow an email address to be stored in and to delete from the second storage unit according to a given operation at the input unit;
an email send unit configured to control the first storage unit and the second storage unit to store a destination address of an outgoing email therein, the destination address input according to a given operation at the input unit, or selected from addresses stored in the first storage unit;
a delete unit configured to control the first storage unit to delete a given email address there from, while controlling the second storage unit to delete the given email address therefrom when the given email address is stored in the second storage unit; and
a receive unit configured to receive a body of an incoming email when a sender's address of the incoming email is stored in the second storage unit.

3. The apparatus of claim 1, further comprising: a display unit;
wherein
the destination address is stored in the storage unit associated with identification information; and
the edit unit displays the destination address and the identification information on the display unit.

4. The apparatus of claim 2, further comprising: a display unit;
wherein
the destination address is stored in the second storage unit associated with identification information; and
the edit unit displays the destination address on the display unit.

5. The apparatus of claim 1,
wherein the edit unit allows at least a portion of a domain name of the email address to be stored in the storage unit; and
the email receive unit receives the body of the incoming email when the at least a portion of the domain name is stored in the storage unit.

6. The apparatus of claim 2,
wherein the edit unit allows at least a portion of a domain name of the email address to be stored in the second storage unit; and
the email receive unit receives the body of the incoming email when the at least a portion of the domain name is stored in the second storage unit.

7. A communication apparatus, comprising:
an input unit;
a storage unit;
an edit unit configured to control the storage unit to store an email address input according to a given operation at the input unit;
an email send unit configured to control the storage unit to delete a destination address of an outgoing email when the destination address is stored in the storage unit; and
an email receive unit configured not to receive a body of an incoming email when a sender's address of email address of the email is stored in the storage unit.

8. A communication apparatus, comprising:
an input unit;
a first storage unit;
a second storage unit;
an edit unit configured to allow an email address to be stored in and deleted from the second storage unit according to a given operation at the input unit;
an email send unit configured to control the first storage unit to store a destination address of an outgoing email therein, while controlling the second storage unit to delete the destination address therefrom when the destination address is stored in the second storage unit, the destination address input according to a given operation at the input unit or selected from addresses stored in the first storage unit;
a delete unit configured to control the first storage unit to delete a given address therefrom and to control the second storage unit to store the given address therein according to a given operation at the input unit; and
a receive unit configured not to receive a body of an incoming email when a sender's address of the incoming email is stored in the second storage unit.

9. The apparatus of claim 8, further comprising a display unit;
wherein
the destination address is stored in the storage unit associated with identification information; and
the edit unit displays the email address and the identification information on the display unit.

10. The apparatus of claim 8, further comprising a display unit;
wherein
the destination address is stored in the second storage unit associated with identification information; and
the edit unit displays the destination address and the identification information on the display unit.

11. The apparatus of claim 8,
wherein
the edit unit allows at least a portion of a domain name of the email address to be stored in the storage unit; and
the email receive unit does not receive the body of the incoming email when the at least a portion of the domain name is stored in the storage unit.

12. The apparatus of claim 9,
wherein
the edit unit allows at least a portion of a domain name of the email address to be stored in the second storage unit; and
the email receive unit does not receive the body of the incoming email when the at least a portion of the domain name is stored in the second storage unit.
